(19) United States
(12) Patent Application Publication
(10) Pub. No.: US 2025/0168832 A1
(43) Pub. Date: May 22, 2025

(54) FREQUENCY DOMAIN RESOURCE ALLOCATION INDICATIONS FOR TRANSFORM PRECODING IN MULTIPLE TRANSMIT RECEIVE POINT DEPLOYMENTS

(71) Applicant: QUALCOMM INCORPORATED, San Diego, CA (US)

(72) Inventors: Fang Yuan, Beijing (CN); Yan Zhou, San Diego, CA (US); Mostafa Khoshnevisan, San Diego, CA (US); Jing Sun, San Diego, CA (US); Wooseok Nam, San Diego, CA (US); Tao Luo, San Diego, CA (US); Xiaoxia Zhang, San Diego, CA (US); Peter Gaal, San Diego, CA (US)

(21) Appl. No.: 18/839,015

(22) PCT Filed: Apr. 12, 2022
(86) PCT No.: PCT/CN2022/086259

§ 371 Date: Aug. 15, 2024

(51) Int. Cl. H04W 72/0453; H04W 72/21

(52) U.S. Cl. CPC H04W 72/0453; H04W 72/21

(57) ABSTRACT

Methods, systems, and devices for wireless communications are described. A user equipment (UE) may receive a downlink control information (DCI) message that includes a frequency domain resource allocation (FDRA). The FDRA may indicate a set of resource blocks (RBs), and the UE uses the indicated set of RBs to identify a first set of RBs for uplink communications using a first transmission configuration indicator (TCI) state and a second set of RBs for uplink communications using a second TCI state, both of which satisfy a threshold for performing transform precoding. The UE may transform precoding the first uplink signaling and the second uplink signaling based on the first and second sets of RBs satisfying the threshold for performing transform precoding.

### CROSS REFERENCE

The present application is a 371 national stage filing of International PCT Application No. PCT/CN2022/086259 by Yuan et al. entitled “FREQUENCY DOMAIN RESOURCE ALLOCATION INDICATIONS FOR TRANSFORM PRECODING IN MULTIPLE TRANSMIT RECEIVE POINT DEPLOYMENTS,” filed Apr. 12, 2022, which is assigned to the assignee hereof, and which is expressly incorporated by reference in its entirety herein.

### FIELD OF TECHNOLOGY

The following relates to wireless communications, including frequency domain resource allocation indications for transform precoding in multiple transmit receive point deployments.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support frequency domain resource allocation indications for transform precoding in multiple transmit receive point deployments. A user equipment (UE) may receive a downlink control information (DCI) message to the UE that includes a frequency domain resource allocation (FDRA). The FDRA may indicate a set of resource blocks (RBs), and the UE uses the indicated set of RBs to identify a first set of RBs for the first TCI state and a second set of RBs for the second TCI state, both of which satisfy a threshold for transform precoding. In some examples, the FDRA may indicate a single set of RBs (the first set of RBs), and the UE may identify the second set of RBs by extending the FDRA indication. The indicated set of RBs may satisfy the threshold (e.g., and by extension, the second set of RBs may satisfy the threshold). In some examples, the FDRA may indicate a single set of RBs, and the UE may split the indicated set of RBs into two equal parts (e.g., the first set of RBs for the first TCI state and the second set of RBs for the second TCI state). The single set of RBs may satisfy twice the threshold, such that each equal half of the single set of RBs satisfies the threshold. In some examples, the FDRA may indicate a single set of RBs, and the UE may perform a flooring or ceiling operating to determine two unequal sets of RBs for the two TCI states. Each of the two sets of RBs may satisfy the threshold.

A method for wireless communications at a user equipment (UE) is described. The method may include receiving an indication of a configuration of a first beam configuration and a second beam configuration, receiving a downlink control information message including a frequency domain resource allocation field indicating a first set of frequency resources associated with the first beam configuration, where a first number of frequency resources in the first set of frequency resources satisfies a first transform precoding threshold number of frequency resources, and transmitting a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

An apparatus for wireless communications at a UE is described. The apparatus may include a processor, memory coupled with the processor, and instructions stored in the memory. The instructions may be executable by the processor to cause the apparatus to receive an indication of a configuration of a first beam configuration and a second beam configuration, receive a downlink control information message including a frequency domain resource allocation field indicating a first set of frequency resources associated with the first beam configuration, where a first number of frequency resources in the first set of frequency resources satisfies a first transform precoding threshold number of frequency resources, and transmit a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

Another apparatus for wireless communications at a UE is described. The apparatus may include means for receiving an indication of a configuration of a first beam configuration and a second beam configuration, means for receiving a downlink control information message including a frequency domain resource allocation field indicating a first set of frequency resources associated with the first beam configuration, where a first number of frequency resources in the first set of frequency resources satisfies a first transform precoding threshold number of frequency resources, and means for transmitting a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

A non-transitory computer-readable medium storing code for wireless communications at a UE is described. The code may include instructions executable by a processor to receive an indication of a configuration of a first beam configuration and a second beam configuration, receive a downlink control information message including a frequency domain resource allocation field indicating a first set of frequency resources associated with the first beam configuration, where a first number of frequency resources in the first set of frequency resources satisfies a first transform precoding threshold number of frequency resources, and transmit a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

In some examples of the method, apparatuses, and non-transitory computer-readable medium described herein, transform precoding the first uplink message based on the first number of frequency resources satisfying the first transform precoding threshold number of frequency resources, where transmitting the first uplink message may be based on transform precoding the first uplink message and transform precoding the second uplink message based on the second number of frequency resources satisfying the second transform precoding threshold number of frequency resources, where transmitting the second uplink message may be based on transform precoding the second uplink message.

Some examples of the method, apparatuses, and non-transitory computer-readable medium described herein may further include operations, features, means, or instructions for extending the first set of frequency resources in the frequency domain to identify the second set of frequency resources, where the first number of frequency resources may be equal to the second number of frequency resources.

In some examples of the method, apparatuses, and non-transitory computer-readable medium described herein, the first transform precoding threshold number of frequency resources may be equal to the second transform precoding threshold number of frequency resources.

Some examples of the method, apparatuses, and non-transitory computer-readable medium described herein may further include operations, features, means, or instructions for receiving, in the frequency domain resource allocation field, a single indication of a set of multiple frequency resources including the first set of frequency resources and the second set of frequency resources.

Some examples of the method, apparatuses, and non-transitory computer-readable medium described herein may further include operations, features, means, or instructions for dividing the set of multiple frequency resources into a first portion including the first set of frequency resources and a second portion including the second set of frequency resources, where the first number of frequency resources may be equal to the second number of frequency resources.

In some examples of the method, apparatuses, and non-transitory computer-readable medium described herein, the set of multiple frequency resources satisfies a threshold value equal to a sum of the first transform precoding threshold number of frequency resources and the second transform precoding threshold number of frequency resources.

In some examples of the method, apparatuses, and non-transitory computer-readable medium described herein, the first transform precoding threshold number of frequency resources may be equal to the second transform precoding threshold number of frequency resources.

Some examples of the method, apparatuses, and non-transitory computer-readable medium described herein may further include operations, features, means, or instructions for dividing, according to a flooring procedure, the set of multiple frequency resources into a first portion including the first set of frequency resources and a second portion including the second set of frequency resources, where the first number of frequency resources may be different from the second number of frequency resources.

In some examples of the method, apparatuses, and non-transitory computer-readable medium described herein, the first transform precoding threshold number of frequency resources may be different from the second transform precoding threshold number of frequency resources.

In some examples of the method, apparatuses, and non-transitory computer-readable medium described herein, transmitting the first uplink message and the second uplink message may include operations, features, means, or instructions for transmitting the first uplink message via a first antenna panel to a first transmit/receive point in a multiple transmit/receive point deployment and transmitting the second uplink message via a second antenna panel to a second transmit/receive point in the multiple transmit/receive point deployment.

A method for wireless communications at a network entity is described. The method may include transmitting an indication of a configuration of a first beam configuration and a second beam configuration, transmitting a downlink control information message including a frequency domain resource allocation field indicating a first set of frequency resources associated with the first beam configuration, where a first number of frequency resources in the first set of frequency resources satisfies a first transform precoding threshold number of frequency resources, and receiving a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

An apparatus for wireless communications at a network entity is described. The apparatus may include a processor, memory coupled with the processor, and instructions stored in the memory. The instructions may be executable by the processor to cause the apparatus to transmit an indication of a configuration of a first beam configuration and a second beam configuration, transmit a downlink control information message including a frequency domain resource allocation field indicating a first set of frequency resources associated with the first beam configuration, where a first number of frequency resources in the first set of frequency resources satisfies a first transform precoding threshold number of frequency resources, and receive a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

Another apparatus for wireless communications at a network entity is described. The apparatus may include means for transmitting an indication of a configuration of a first beam configuration and a second beam configuration, means for transmitting a downlink control information message including a frequency domain resource allocation field indicating a first set of frequency resources associated with the first beam configuration, where a first number of frequency resources in the first set of frequency resources satisfies a first transform precoding threshold number of frequency resources, and means for receiving a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

A non-transitory computer-readable medium storing code for wireless communications at a network entity is described. The code may include instructions executable by a processor to transmit an indication of a configuration of a first beam configuration and a second beam configuration, transmit a downlink control information message including a frequency domain resource allocation field indicating a first set of frequency resources associated with the first beam configuration, where a first number of frequency resources in the first set of frequency resources satisfies a first transform precoding threshold number of frequency resources, and receive a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

Some examples of the method, apparatuses, and non-transitory computer-readable medium described herein may further include operations, features, means, or instructions for extending the first set of frequency resources in the frequency domain to identify the second set of frequency resources, where the first number of frequency resources may be equal to the second number of frequency resources.

In some examples of the method, apparatuses, and non-transitory computer-readable medium described herein, the first transform precoding threshold number of frequency resources may be equal to the second transform precoding threshold number of frequency resources.

Some examples of the method, apparatuses, and non-transitory computer-readable medium described herein may further include operations, features, means, or instructions for transmitting, in the frequency domain resource allocation field, a single indication of a set of multiple frequency resources including the first set of frequency resources and the second set of frequency resources.

Some examples of the method, apparatuses, and non-transitory computer-readable medium described herein may further include operations, features, means, or instructions for allocating a first portion of the set of multiple frequency resources including the first set of frequency resources for the first beam configuration and a second portion of the set of multiple frequency resources including the second set of frequency resources for the second beam configuration, where the first number of frequency resources may be equal to the second number of frequency resources.

In some examples of the method, apparatuses, and non-transitory computer-readable medium described herein, the set of multiple frequency resources satisfies a threshold value equal to a sum of the first transform precoding threshold number of frequency resources and the second transform precoding threshold number of frequency resources.

In some examples of the method, apparatuses, and non-transitory computer-readable medium described herein, the first transform precoding threshold number of frequency resources may be equal to the second transform precoding threshold number of frequency resources.

Some examples of the method, apparatuses, and non-transitory computer-readable medium described herein may further include operations, features, means, or instructions for allocating, according to a flooring procedure, the set of multiple frequency resources into a first portion including the first set of frequency resources and a second portion including the second set of frequency resources, where the first number of frequency resources may be different from the second number of frequency resources.

In some examples of the method, apparatuses, and non-transitory computer-readable medium described herein, the first transform precoding threshold number of frequency resources may be different from the second transform precoding threshold number of frequency resources.

### BRIEF DESCRIPTION OF THE DRAWINGS

FIG. 1 illustrates an example of a wireless communications system that supports frequency domain resource allocation indications for transform precoding in multiple transmit receive point deployments in accordance with one or more aspects of the present disclosure.

FIG. 2 illustrates an example of a wireless communications system that supports frequency domain resource allocation indications for transform precoding in multiple transmit receive point deployments in accordance with one or more aspects of the present disclosure.

FIG. 3 illustrates an example of a flow diagram that supports frequency domain resource allocation indications for transform precoding in multiple transmit receive point deployments in accordance with one or more aspects of the present disclosure.

FIG. 4 illustrates an example of a resource allocation scheme that supports frequency domain resource allocation indications for transform precoding in multiple transmit receive point deployments in accordance with one or more aspects of the present disclosure.

FIG. 5 illustrates an example of a resource allocation scheme that supports frequency domain resource allocation indications for transform precoding in multiple transmit receive point deployments in accordance with one or more aspects of the present disclosure.

FIG. 6 illustrates an example of a resource allocation scheme that supports frequency domain resource allocation indications for transform precoding in multiple transmit receive point deployments in accordance with one or more aspects of the present disclosure.

FIG. 7 illustrates an example of a process flow that supports frequency domain resource allocation indications for transform precoding in multiple transmit receive point deployments in accordance with one or more aspects of the present disclosure.

FIGS. 8 and 9 show block diagrams of devices that support frequency domain resource allocation indications for transform precoding in multiple transmit receive point deployments in accordance with one or more aspects of the present disclosure.

FIG. 10 shows a block diagram of a communications manager that supports frequency domain resource allocation indications for transform precoding in multiple transmit receive point deployments in accordance with one or more aspects of the present disclosure.

FIG. 11 shows a diagram of a system including a device that supports frequency domain resource allocation indications for transform precoding in multiple transmit receive point deployments in accordance with one or more aspects of the present disclosure.

FIGS. 12 and 13 show block diagrams of devices that support frequency domain resource allocation indications for transform precoding in multiple transmit receive point deployments in accordance with one or more aspects of the present disclosure.

FIG. 14 shows a block diagram of a communications manager that supports frequency domain resource allocation indications for transform precoding in multiple transmit receive point deployments in accordance with one or more aspects of the present disclosure.

FIG. 15 shows a diagram of a system including a device that supports frequency domain resource allocation indications for transform precoding in multiple transmit receive point deployments in accordance with one or more aspects of the present disclosure.

FIGS. 16 through 20 show flowcharts illustrating methods that support frequency domain resource allocation indications for transform precoding in multiple transmit receive point deployments in accordance with one or more aspects of the present disclosure.

### DETAILED DESCRIPTION

A user equipment (UE) in a wireless communications system may operate in a multiple transmit receive point (mTRP) deployment. The UE may communicate with a first TRP using a first antenna panel and a first transmission configuration indicator (TCI) state and a second antenna panel and a second TCI state. The UE may also be configured to perform precoding (e.g., transform precoding) for uplink signaling. To support transform precoding for frequency division multiplexing (FDM) uplink signaling, the UE must be allocated with at least a threshold number of frequency resources (resource blocks (RBs)). If the network allocates a number of resources to the UE such that resources allocated for one TCI state, or the other TCI state, do not satisfy the threshold, then the UE may be unable to perform transform precoding. Some wireless communications systems do not provide a mechanism to ensure that resources allocated for the first TCI state satisfy the threshold, and resources allocated for the second TCI state also satisfy the threshold.

The network may transmit a downlink control information (DCI) message to the UE that includes a frequency domain resource allocation (FDRA). The FDRA may indicate a set of RBs, and the UE uses the indicated set of RBs to identify a first set of RBs for the first TCI state and a second set of RBs for the second TCI state, both of which satisfy the threshold. In some examples, the FDRA may indicate a single set of RBs (the first set of RBs), and the UE may identify the second set of RBs by extending the FDRA indication. The indicated set of RBs may satisfy the threshold (e.g., and by extension, the second set of RBs may satisfy the threshold). In some examples, the FDRA may indicate a single set of RBs, and the UE may split the indicated set of RBs into two equal parts (e.g., the first set of RBs for the first TCI state and the second set of RBs for the second TCI state). The single set of RBs may satisfy twice the threshold, such that each equal half of the single set of RBs satisfies the threshold. In some examples, the FDRA may indicate a single set of RBs, and the UE may perform a flooring or ceiling operating to determine two unequal sets of RBs for the two TCI states. Each of the two sets of RBs may satisfy the threshold.

Aspects of the disclosure are initially described in the context of wireless communications systems. Aspects of the disclosure are further illustrated by and described with reference to wireless communications systems, flow diagrams, resource allocation schemes, and process flows. Aspects of the disclosure are further illustrated by and described with reference to apparatus diagrams, system diagrams, and flowcharts that relate to frequency domain resource allocation indications for transform precoding in multiple transmit receive point deployments.

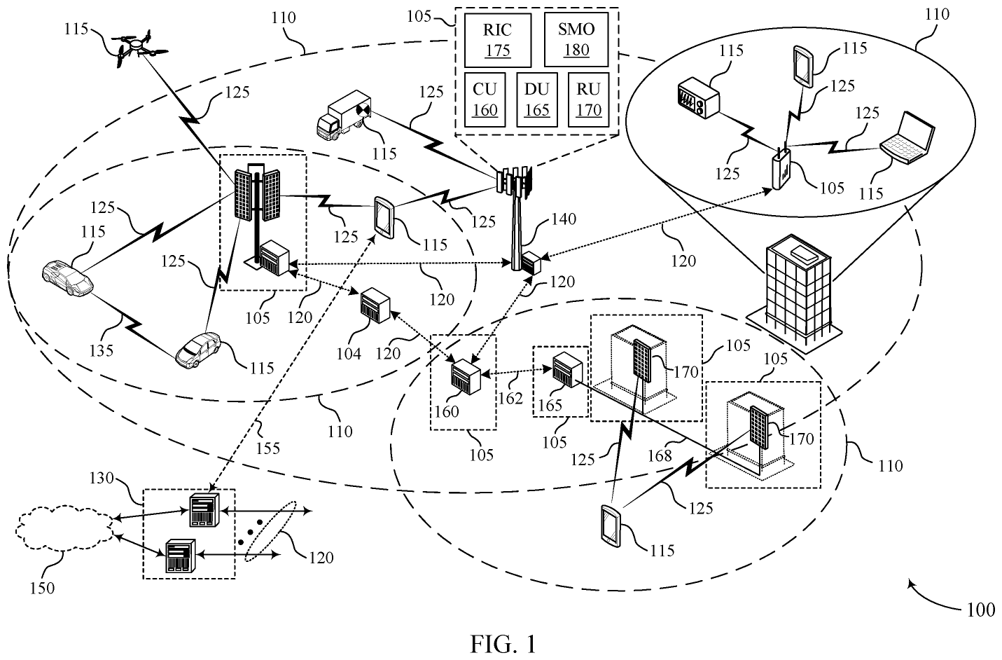

FIG. 1 illustrates an example of a wireless communications system 100 that supports frequency domain resource allocation indications for transform precoding in multiple transmit receive point deployments in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support frequency domain resource allocation indications for transform precoding in multiple transmit receive point deployments as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunications system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, a UE 115 may receive a DCI message to the UE 115 that includes an FDRA field. The FDRA may indicate a set of RBs, and the UE 115 may use the indicated set of RBs to identify a first set of RBs for a first TCI state and a second set of RBs for a second TCI state, both of which satisfy a threshold for transform precoding. In some examples, the FDRA may indicate a single set of RBs (the first set of RBs), and the UE 115 may identify the second set of RBs by extending the FDRA indication. The indicated set of RBs may satisfy the threshold (e.g., and by extension, the second set of RBs may satisfy the threshold). In some examples, the FDRA may indicate a single set of RBs, and the UE 115 may split the indicated set of RBs into two equal parts (e.g., the first set of RBs for the first TCI state and the second set of RBs for the second TCI state). The single set of RBs may satisfy twice the threshold, such that each equal half of the single set of RBs satisfies the threshold. In some examples, the FDRA may indicate a single set of RBs, and the UE may perform a flooring operating to determine two unequal sets of RBs for the two TCI states. Each of the two sets of RBs may satisfy the threshold.

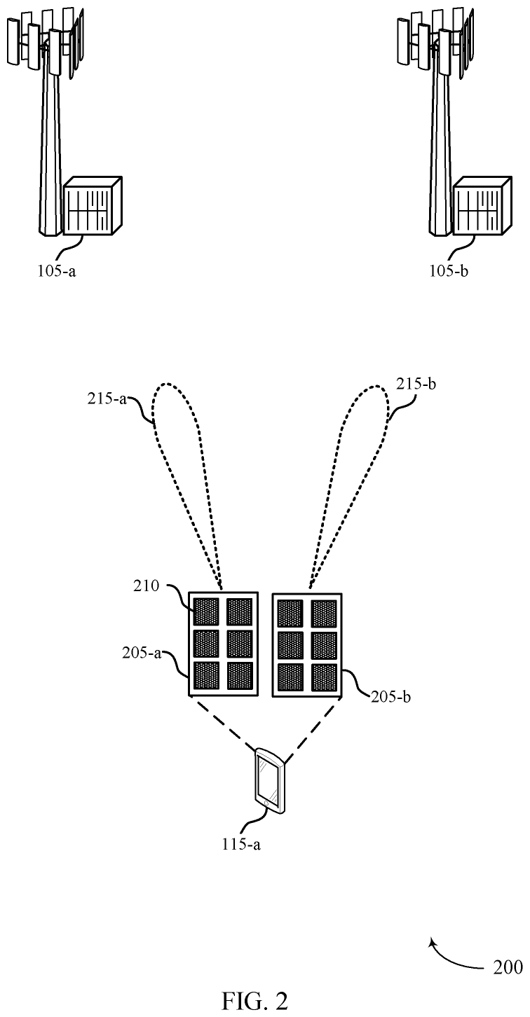

FIG. 2 illustrates an example of a wireless communications system 200 that supports frequency domain resource allocation indications for transform precoding in multiple transmit receive point deployments in accordance with one or more aspects of the present disclosure. The wireless communication system 200 may include one or more network entities 105 (e.g., the network entity 105-a and the network entity 105-b), one or more UEs 115 (e.g., the UE 115-a), which may be examples of corresponding devices described with reference to FIG. 1.

The UE 115-a may communicate using one or more antenna panels 205 (e.g., a first antenna panel 205-a and a second antenna panel 205-b). Each antenna panel 205-a may include one or more antenna elements 210. The UE 115-a may generate one or more beams 215 (e.g., using the different antenna elements 210, the different antenna panels 205, etc.). For example, the UE 115-a may generate a beam 215-a for communicating with the network entity 105-a, and may generate a beam 215-b for communicating with the network entity 105-b.

The wireless communications system 200 may support mTRP deployments. For example, the UE 115-a may communicate with a first TRP (e.g., the network entity 105-a) and a second TRP (e.g., the network entity 105-b). In some examples, the UE 115-a may support a unified TCI state framework for indication of multiple downlink and uplink TCI states (e.g., multiple uplink and downlink beams 215). In such examples, the network may provide (e.g., via the network entity 105-a, the network entity 105-b, or both) an indication of a first TCI state (e.g., a beam configuration associated with the beam 215-a) and a second TCI state (e.g., a beam configuration associated with the beam 215-b). A TCI state may be referred to as a beam configuration, which may indicate antenna configuration or other parameters for generating a particular beam. In some examples, the UE 115-a may support simultaneous multi-panel uplink transmissions, which may result in higher uplink throughput and increased reliability (e.g., for communications in FR1 or FR2 or both, in mTRP deployments). For example, the UE 115-a may support communications with up to two TRPs (e.g., the network entity 105-a and the network entity 105-b), up to two antenna panels (e.g., the antenna panel 205-a and the antenna panel 205-b), which may support improved communications in a customer premise equipment (CPE), fixed wireless access (FWA), vehicles, industrial devices, or any other deployment.

The UE 115-a may support a precoding indication for uplink signaling (e.g., on a physical uplink shared channel), for multi-panel simultaneous transmissions. A number of layers supported by the UE 115-a may be up to four, across all panels 205 and a total number of codewords supported by the UE 115-a may be up to two across all panels 205, considering single DCI and multi-DCI based mTRP operations. In some examples, the UE 115-a may support uplink beam indications for physical uplink control channel (PUCCH) or PUSCH transmissions (e.g., based on a unified TCI framework, considering single DCI and multi-DCI based mTRP operations). In some examples, for multi-DCI mTRP operations, the UE 115-a may support PUSCH and PUSCH transmissions, or PUCCH and PUCCH transmissions transmitted across two panels 205 and in a same component carrier.

In some examples, the UE 115-a may support mTRP operations according to multiple TCI states (e.g., beams 215). The UE 115-a may receive downlink communications (e.g., PDCCH or PDSCH) via different beams, different quasi colocation (QCL) scenarios, different TRPs, different SRS resource indicators (SRIs) or a combination thereof. For example, the UE 115-a may multiplex (e.g., spatial division multiplexing (SDM), frequency division multiplexing (FDM), or time division multiplexing (TDM)) uplink signaling or downlink signaling using the first panel 205-a and/or the first beam 215-a, and uplink signaling or downlink signaling using the second panel 205-b and/or the second beam 215-b. The UE may perform mTRP communications (e.g., TDM uplink and/or downlink communications) according to a cyclic mapping (e.g., alternating over time between communications using the first beam 215-a and/or the first panel 205-a and the second beam 215-b and/or the second panel 205-b), or a sequential mapping (e.g., communicating according to the first beam 215-a and/or the first panel 205-a, and then communicating according to the second beam 215-b and/or the second panel 205-b). In some examples, the UE 115-a may perform DCI repetition. For instance, the UE 115-a may receive a first repetition of a DCI message using the first beam 215-a and/or the first panel 205-a, and may receive a second repetition of the DCI message using the second beam 215-b and/or the second panel 205-b. The UE 115-a may perform uplink repetitions (e.g., transmitting a first repetitions of an uplink message on a PUSCH or PUCCH using the first beam 215-a and/or the first panel 205-a, and a second repetition of the uplink message on the PUSCH or PUCCH using the second beam 215-b and/or the second panel 205-b). In some examples, the UE 115-a may multiplex (e.g., TDM, FDM, or SFN) the repetitions using different beams and/or panels for respective repetitions of the uplink message.

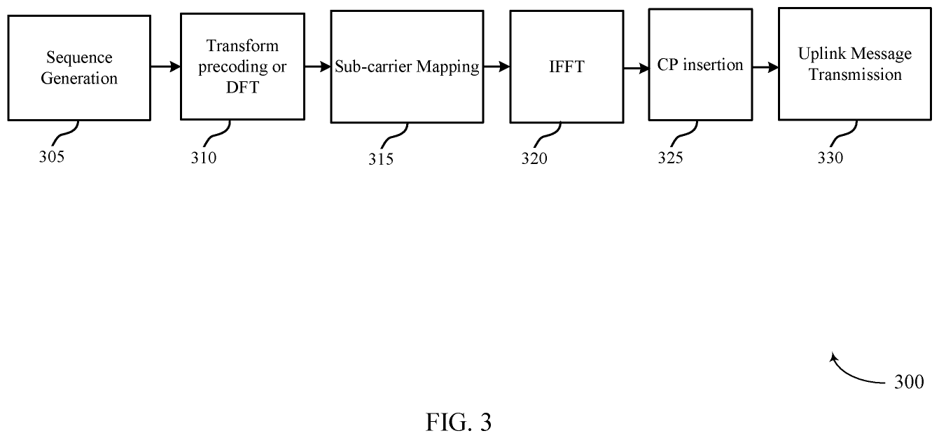

In some examples, the UE 115-a may support transform precoding of uplink transmissions in an mTRP deployment, as described in greater detail with reference to FIG. 3. The UE 115-a may FDM uplink signaling to the first network entity 105-a (e.g., using the first beam 215-a and the first panel 205-a) and the second network entity 105-b (e.g., using the second beam 215-b and the second panel 205-b). The network may allocate resources to the UE 115-a (e.g., via an FDRA field in a DCI message), and the UE 115-a may interpret the allocation of resources to identify a subset of frequency resources for communicating with the first network entity 105-a using the first beam 215-a and the first panel 205-a, and a second subset of the frequency resources for communicating with the second network entity 105-b using the second beam 215-b and the second panel 205-b).

FIG. 3 illustrates an example of a flow diagram 300 that supports frequency domain resource allocation indications for transform precoding in multiple transmit receive point deployments in accordance with one or more aspects of the present disclosure. In some examples, flow diagram 300 may implement aspects of wireless communications systems 100 or 200. For example, a UE 115 as described with respect to FIGS. 1 and 2 may utilize flow diagram 300 to generate and transmit a message 325.

The UE 115 may generate an uplink message for transmission to a first TRP, a second TRP, or both. The UE 115 may generate a sequence 305. The flow diagram 300 may illustrate one example of the process of generating and transmitting a sequence (e.g., based on a DFT/IDFT matrix identified by a UE 115). At 305, the UE 115 may generate a sequence.

At 310, the UE 115 may perform transform precoding or DFT so that the UE 115 may transmit the uplink message in the time domain. The ability to transmit the uplink message in the time domain or the frequency domain may provide additional flexibility which may improve efficient resource utilization and further decrease the likelihood of transmission interference between multiple UEs 115. In some examples, the UE 115 may apply the transform precoding according to Equation 1:

$${y}^{( 0 )} ( l \cdot {M}_{SC}^{PUSCH} + k = \frac{1}{\sqrt{{M}_{SC}^{PUSCH}}} {\sum }_{i = 0}^{{M}_{SC}^{PUSCH} - 1} {\tilde{x}}^{0} ( l \cdot {M}_{SC}^{PUSCH} + 1 ) {e}^{\frac{2 π i k}{{M}_{SC}^{PUSCH}}} \qquad Equation 1$$

where k=0, . . . , M_{SC}^{PUSCH}−1, and l=0, . . . , M_{symb}^{layer}/M_{SC}^{PUSCH}−1, resulting in a block of complex-valued symbols y⁽⁰⁾(0), . . . , y⁽⁰⁾(M_{symb}^{layer}−1). The variable M_{SC}^{PUSCH}=M_{RB}^{PUSCH}, where M_{RB}^{PUSCH} describes a bandwidth of a PUSCH in terms of resource blocks. To support successful transform precoding may satisfy M_{RB}^{PUSCH}=2^{α}^{₂}·3^{α}^{₃}·5^{α}^{₅}, where α₅, α₅, and as is a set of non-negative integers. If an allocated block of resources does not satisfy the prime factorization of 2^{α}^{₂}·3^{α}^{₃}·5^{α}^{₅}, then the UE 115 may not support transform precoding.

At 315, the UE 115 may perform subcarrier mapping. The UE 115 may map the sequence to subcarriers to transmit the sequence. The UE 115 may then perform an inverse fast Fourier transform (IFFT) at 320, and may add a cyclic prefix at 325. Finally, the UE 115 may transmit the uplink message at 330.

In some examples, as described herein, the UE 115 may transform precode a first message for a first TRP and a second message for a second TRP (e.g., repetitions on a PUCCH or PUSCH). In such examples, the UE may only support transform precoding for the two separate messages if a set of frequency resources (e.g., M_{RB}^{PUSCH}) for transmitting the first message satisfies a threshold number of frequency resources (e.g., M_{RB}^{PUSCH}=2^{α}^{₂}·3^{α}^{₃}·5^{α}^{₅}) and a second set of frequency resources (e.g., M_{RB}^{PUSCH}) for transmitting the second message satisfies a threshold number of frequency resources (e.g., M_{RB}^{PUSCH}=2^{α}^{₂}·3^{α}^{₃}·5^{α}^{₅}).

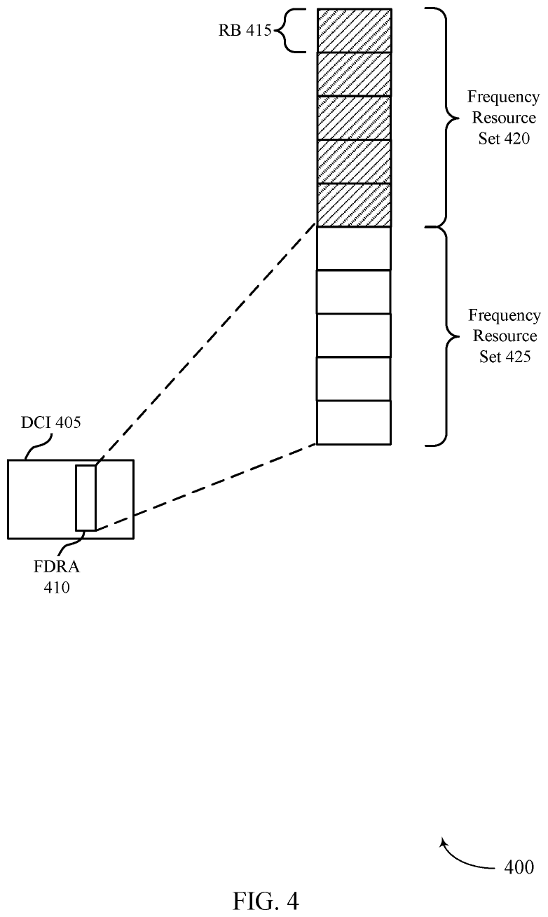

As described in greater detail with reference to FIGS. 4-7, the network may indicate (e.g., in an FDRA field of a DCI message, or in a RRC configuration) an allocation of frequency resources for communicating uplink signaling (e.g., on a PUSCH or PUCCH). The UE may divide the allocated resources into, or may otherwise derive, a first set of frequency resources and a second set of frequency resources. If one or both of the sets of frequency resources do not satisfy the threshold number of frequency resources, then the UE may not be able to transform precode the uplink messages.

As described herein, for FDM multi-panel uplink PUSCH transmission configured with transform precoding, one FDRA 410 may be indicated by the DCI 405 to the UE. Based on the FDRA 410, the UE may derive two sets of RBs 415 allocated for two TCI states (which may be associated with two panels), respectively. The number of RBs 415 in each set for each panel/TCI state may satisfy the threshold number of frequency resources (e.g., M_{RB,i}^{PUSCH}=2^{α}^{₂}3^{α}^{₃}5^{α}^{₅}, where i=0, 1 (e.g., for the two TCI states/panels), and where α₂, α₃ and α⁵ are non-negative integers. the network may allocate resources, and the UE may determine resources, such that a subset of allocated frequency resources for the first TCI state, first antenna panel, first SRI, or any combination thereof (e.g., as described with reference to FIG. 2), satisfy the threshold number of frequency resources, and a subset of allocated frequency resources for the second TCI state, second antenna panel, second SRI, or any combination thereof (e.g., as described with reference to FIG. 2), satisfy the threshold number of frequency resources.

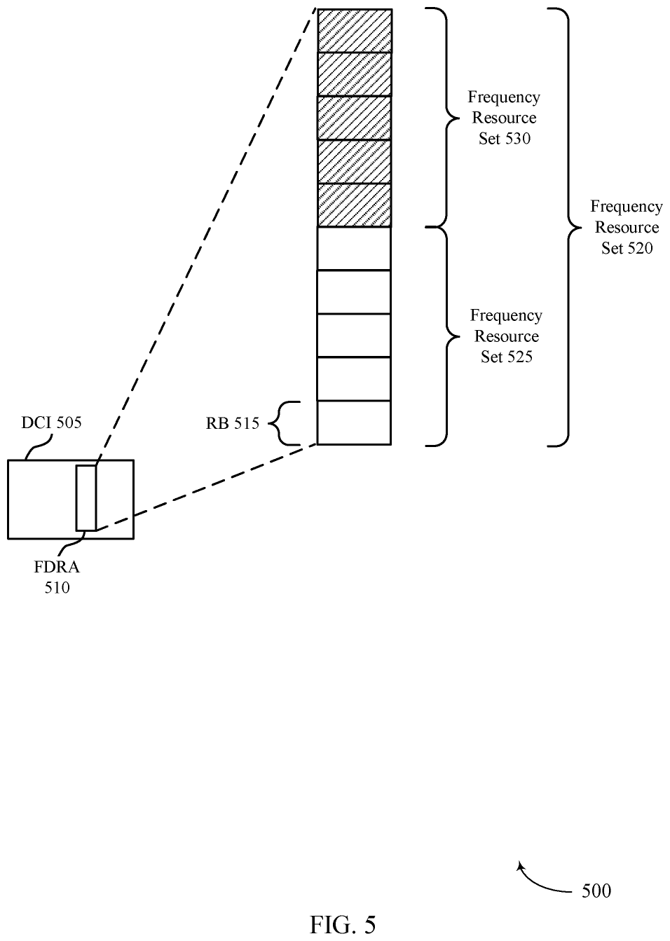

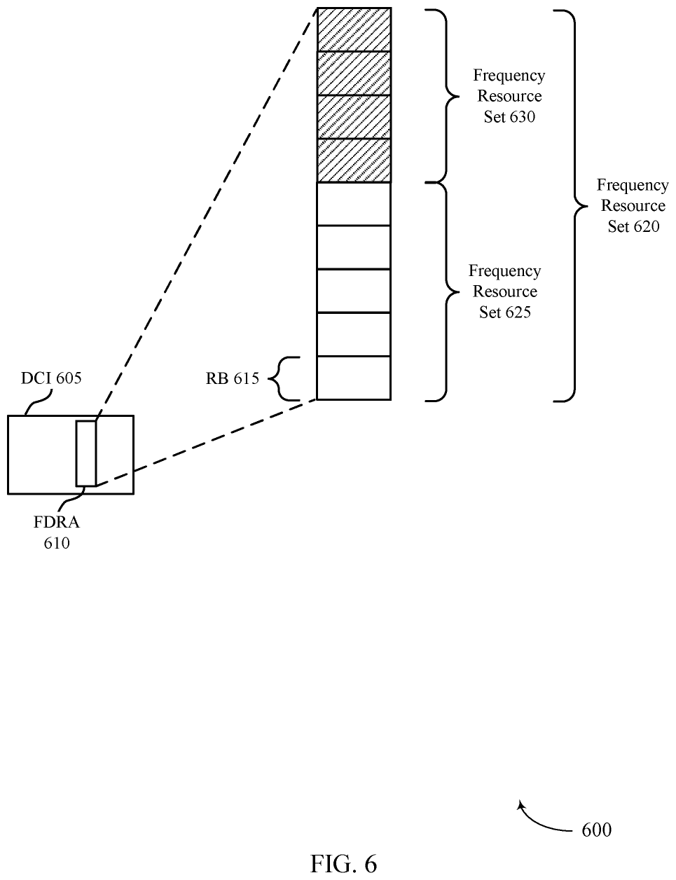

In some examples, as described with reference to FIG. 4, the network may indicate a single set of frequency resources, via an FDRA, that satisfies the threshold number of frequency resources. The UE may extend the indicated single set of frequency resources to identify a second set of frequency resources, such that both the first and second sets of frequency resources satisfy the threshold number of frequency resources. In some examples, as described with reference to FIG. 5, the network may indicate a single group of frequency resources, via an FDRA indication, that satisfies at least twice the threshold number of frequency resources. The UE may evenly divide the allocated group of frequency resources into a first set of frequency resources and a second set of frequency resources, each of which satisfies the threshold number of frequency resources. In some examples, as described with reference to FIG. 6, the network may indicate a single group of frequency resources, via an FDRA indication, that can be divided unevenly. The UE may divide the group of frequency resources into two uneven groups using a flooring or ceiling operation, such that each of the first and second sets of frequency resources satisfy the threshold number of frequency resources.

FIG. 4 illustrates an example of a resource allocation scheme 400 that supports frequency domain resource allocation indications for transform precoding in multiple transmit receive point deployments in accordance with one or more aspects of the present disclosure. Resource allocation scheme 400 may implement, or be implemented by, aspects of wireless communications system 100, wireless communication system 200, or flow diagram 300. For instance, a UE (e.g., a UE 115) may communicate with one or more TRPs (e.g., a first network entity 105 and a second network entity 105) in an mTRP deployment. The UE and the TRPs may be examples of corresponding devices described with reference to FIGS. 1-3.

The UE may operate using one or more TCI states, one or more panels, one or more SCIs, or a combination thereof. For instance, in a unified TCI state, the DCI 405 may indicate a pair of TCI states that the UE is to use for communicating with the first TRP and the second TRP, respectively. For FDM multi-panel uplink transmissions configured with transform precoding (e.g., the network provides an indication enabling the UE to perform transform precoding), one FDRA 410 is indicated by the DCI 405, and two FDRA partitions associated with two panels/TCI states (e.g., frequency resource set 420 and frequency resource set 425) may be determined by the UE.

For example, the UE may receive the DCI 405 (e.g., from one of the multiple TRPs, or may receive multiple repetitions of the DCI 405 from the different TRPs using different TCI states, as described with reference to FIG. 2). The DCI 405 may include an FDRA 410 (e.g., in an FDRA field). The FDRA 410 may indicate a set of frequency domain resources (e.g., RBs 415) allocated to the first TCI or the first antenna panel. For instance, the FDRA 410 may indicate frequency resource set 425. Frequency resource set 425 may include a number (e.g., 5) of RBs 415. The frequency resource set 425 may satisfy the threshold number of frequency resources (e.g., M_{RB}^{PUSCH}=2^{α2}3^{α3}5^{α5}, where α₂, α₃ and α₅ are non-zero integers). For instance, where M_{RB}^{PUSCH}=5, if α₂=0, α₃=0, and α₅=1, then M_{RB}^{PUSCH}=2⁰3⁰5¹=5 RBs.

The frequency resource set 420 may be allocated to the second TCI or second antenna panel at the UE based on an extension of the frequency resource set 425 indicated by the FDRA 410. For example, the UE may extend the frequency resource set 425 (e.g., in the direction of higher frequency, as illustrated with reference to FIG. 4, or in the direction of lower frequency, according to a rule in one or more standards or according to an instruction received from the network). The UE may determine that frequency resource set 420 is equal to and adjacent to frequency resource set 425 (e.g., includes the same number of RBs 415). Because the FDRA 410 indicates frequency resource set 425 (e.g., 5 RBs), the UE may identify a next set of adjacent frequency resources (e.g., frequency resource set 420) having the same number of frequency resources (e.g., 5 RBs) as frequency resource set 425). Because the FDRA 410 indicates a number of frequency resources (e.g., the frequency resource set 425) that satisfies the threshold number of frequency resources (e.g., M_{RB}^{PUSCH}=2^{α}^{₂}3^{α}^{₃}5^{α}^{₅}), the frequency resource set 420 may also satisfy the threshold number of frequency resources. Thus, frequency resource set 425 may represent an FDRA that equals M_{RB}^{PUSCH}, and frequency resource set 420 may represent an extended FDRA that equals M_{RB}^{PUSCH} The network may allocate frequency resource set 425 such that both sets of frequency resources satisfy the threshold.

FIG. 5 illustrates an example of a resource allocation scheme 500 that supports frequency domain resource allocation indications for transform precoding in multiple transmit receive point deployments in accordance with one or more aspects of the present disclosure. Resource allocation scheme 500 may implement, or be implemented by, aspects of wireless communications system 100, wireless communication system 200, or flow diagram 300. For instance, a UE (e.g., a UE 115) may communicate with one or more TRPs (e.g., a first network entity 105 and a second network entity 105) in an mTRP deployment. The UE and the TRPs may be examples of corresponding devices described with reference to FIGS. 1-4.

The UE may operate using one or more TCI states, one or more panels, one or more SCIs, or a combination thereof. For instance, for a unified TCI state, the DCI 505 may indicate a pair of TCI states that the UE is to use for communicating with the first TRP and the second TRP, respectively. For FDM multi-panel uplink transmissions configured with transform precoding (e.g., the network provides an indication enabling the UE to perform transform precoding), one FDRA 510 is indicated by the DCI 505, and two FDRA partitions associated with two panels/TCI states may be determined by the UE.

For example, the UE may receive the DCI 505 (e.g., from one of the multiple TRPs, or may receive multiple repetitions of the DCI 505 from the different TRPs using different TCI states, as described with reference to FIG. 2). The DCI 505 may include an FDRA 510 (e.g., in an FDRA field). The FDRA 510 may indicate a set of frequency domain resources (e.g., RBs 415) to be split between two antenna panels at the UE (e.g., two TCI states). For instance, the FDRA 510 may indicate frequency resource set 520. Frequency resource set 520 may include a number (e.g., 10) of RBs 515. The frequency resource set 520 may satisfy the threshold number of frequency resources (e.g., M_{RB}^{PUSCH}=2·2^{α}^{₂}3^{α}^{₃}5^{α}^{₅}, where α₂, α₃ and α₅ are non-zero integers). For instance, where M_{RB}^{PUSCH}=10, if α₂=1, α₃=0, and α₅=1, then M_{RB}^{PUSCH}=2¹3⁰5¹=10 RBs. The frequency resource set 520 may be divided into frequency resource set 525 (e.g., for the first TCI state and first antenna panel at the UE) and frequency resource set 530 (e.g., for the second TCI state and second antenna panel at the UE).

For example, the UE may select the frequency resource set 525 for one of its TCI states or antenna panels. For example, the TCI state having a lower index value or higher index value may be associated with the frequency resources associated with lower frequency ranges or higher frequency ranges, or the network may configure the UE to map portions of the frequency resource set 520 to TCI states or antenna panels. Because the FDRA 510 indicates frequency resource set 520 (e.g., 10 RBs) that satisfy M_{RB}^{PUSCH}=2·2^{α}^{₂}3^{α}^{₃}5^{α}^{₅}, upon dividing the frequency resource set 520 into to equal halves (e.g., frequency resource set 530 and frequency resource set 525 of 5 RBs each), each of frequency resource set 530 and frequency resource set 525 may each satisfy M_{RB}^{PUSCH}=2·2^{α}^{₂}3^{α}^{₃}5^{α}^{₅}. In such examples, frequency resource set 530 and frequency resource set 525 may include the same number of RBs 515 (e.g., 5 RBs 515 each), and each of frequency resource set 525 and frequency resource set 530 may satisfy M_{RB}^{PUSCH}=2·2^{α}^{₂}3^{α}^{₃}5^{α}^{₅}, where α₂, α₃ and α₅ may be the same for each of frequency resource set 525 and frequency resource set 525. The network may allocate frequency resource set 520 such that equal division of the frequency resources will result in two separate frequency resource sets, each of which satisfy the threshold.

FIG. 6 illustrates an example of a resource allocation scheme 600 that supports frequency domain resource allocation indications for transform precoding in multiple transmit receive point deployments in accordance with one or more aspects of the present disclosure. Resource allocation scheme 600 may implement, or be implemented by, aspects of wireless communications system 100, wireless communication system 200, or flow diagram 300. For instance, a UE (e.g., a UE 115) may communicate with one or more TRPs (e.g., a first network entity 105 and a second network entity 105) in an mTRP deployment. The UE and the TRPs may be examples of corresponding devices described with reference to FIGS. 1-5.

The UE may operate using one or more TCI states, one or more panels, one or more SCIs, or a combination thereof. For instance, for a unified TCI state, the DCI 605 may indicate a pair of TCI states that the UE is to use for communicating with the first TRP and the second TRP, respectively. For FDM multi-panel uplink transmissions configured with transform precoding (e.g., the network provides an indication enabling the UE to perform transform precoding), one FDRA 610 is indicated by the DCI 605, and two FDRA partitions associated with two panels/TCI states may be determined by the UE.

For example, the UE may receive the DCI 605 (e.g., from one of the multiple TRPs, or may receive multiple repetitions of the DCI 605 from the different TRPs using different TCI states, as described with reference to FIG. 2). The DCI 605 may include an FDRA 610 (e.g., in an FDRA field). The FDRA 610 may indicate a set of frequency domain resources (e.g., RBs 615) to be divided between two antenna panels at the UE (e.g., two TCI states). For instance, the FDRA 510 may indicate frequency resource set 620. Frequency resource set 620 may include a number (e.g., n_{PRB}) of RBs 615. A first number of frequency resources (e.g.,

$$⌈ \frac{{n}_{P R B}}{2} ⌉ ,$$

where ┌ . . . ┐ indicates a ceiling operation) may be assigned to the first TCI state (e.g., frequency resource set 625) and a remaining number of frequency resources (e.g.,

$$⌊ \frac{{n}_{P R B}}{2} ⌋ ,$$

where └ . . . ┘ indicates a flooring operation) may be assigned to the second TCI state (e.g., the frequency resource set 630). For instance, the UE may determine that a frequency resource set 625 (e.g., 5 RBs 615) are assigned to the first TCI state, and may determine (e.g., by applying a flooring or ceiling procedure), that the remaining frequency resources of frequency resource set 620 (e.g., 4 RBs 615 of the frequency resource set 630) are assigned to the first TCI state. In such examples, each of the frequency resource set 625 and the frequency resource set 625 may satisfy the threshold number of frequency resources (e.g., M_{RB}^{PUSCH}=2·2^{α}^{₂}3^{α}^{₃}5^{α}^{₅}, where α₂, α₃ and α₅ are non-zero integers).

For instance, if the number of frequency resources for frequency resource set 620 n_{PRB}=9, then

$$⌈ \frac{{n}_{P R B}}{2} ⌉ = 5$$

for frequency resource set 625, and

$$⌊ \frac{{n}_{P R B}}{2} ⌋ = 4$$

for frequency resource set 630, and α₂, α₃ and α₅ for frequency resource set 625 may be different than α′₂, α′₃ and α′₅ for frequency resource set 625. For instance, where

$$⌈ \frac{{n}_{P R B}}{2} ⌉ = 5$$

for the frequency resource set 625, if α₂=0, α₃=0, and α₅=1, then M_{RB}^{PUSCH}=2⁰3⁰5¹=5 RBs, satisfying the threshold number of frequency resources for frequency resource set 625. Similarly, by performing a flooring or ceiling operation,

$$⌊ \frac{{n}_{P R B}}{2} ⌋ = 4$$

for frequency resource set 630, if α₂=2, α₃=0, and α₅=0, then M_{RB}^{PUSCH}=2²3⁰5⁰=4 RBs, satisfying the threshold number of frequency resources for frequency resource set 630. The network may allocate frequency resource set 620 such that the flooring or ceiling operation and division of frequency resources by the UE will result in two separate frequency resource sets, each of which satisfy the threshold.

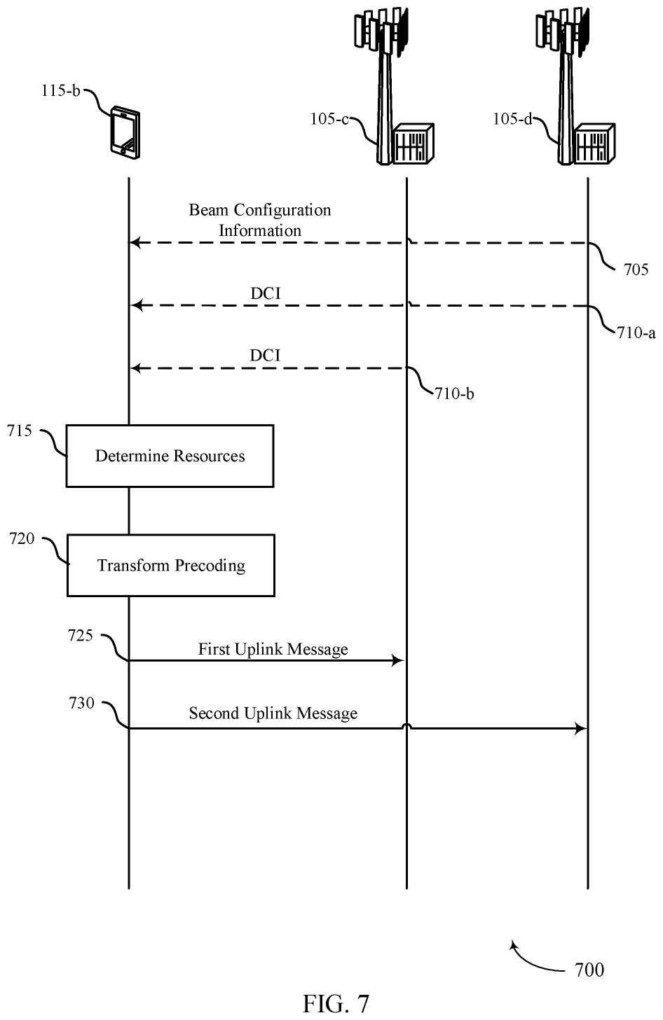

FIG. 7 illustrates an example of a process flow 700 that supports frequency domain resource allocation indications for transform precoding in multiple transmit receive point deployments in accordance with one or more aspects of the present disclosure. Process flow 700 may implement, or be implemented by, aspects of wireless communications system 100 and wireless communications system 200, as well as flow diagram 300, resource allocations scheme 400, resource allocation scheme 500, and resource allocation scheme 600. For example, process flow 700 may include a UE 115-b, a network entity 105-c, and a network entity 105-d, which may be examples of corresponding devices described with reference to FIGS. 1-6.

At 705, the UE 115-b may receive an indication of a configuration of a first beam configuration (e.g., first TCI state) and a second beam configuration (e.g., second TCI state). The UE 115-b may receive the indication of the first and second beam configurations via one network entity (e.g., network entity 105-d), or via multiple network entities (e.g., repetitions of the beam configuration information from the network entity 105-c and the network entity 105-d).

At 710, the UE 115-b may receive a DCI message. The DCI message may include an FDRA field indicating a first set of frequency resources associated with the first TCI state. The first number of frequency resources in the first set of frequency resources may satisfy a threshold (e.g., a first transform precoding threshold number of frequency resources). For instance, the first set of frequency resources may satisfy M_{RB}^{PUSCH}=2·2^{α}^{₂}3^{α}^{₃}5^{α}^{₅}, or

$$⌈ \frac{{n}_{P R B}}{2} ⌉ = {2}^{{α}_{2}} {3}^{{α}_{3}} {5}^{{α}_{5}} .$$

The UE 115-b may receive the DCI message from a single network entity 105 (e.g., at 710-a, or at 710-b), or may receive the DCI via multiple network entities 105 (e.g., may receive repetitions of the DCI from the first network entity 105-c at 710-a and the second network entity 105-d at 710-b). The network entities 105 may allocate frequency resources (e.g., via the FDRA) to indicate frequency resources for both the first TCI state and the second TCI state, such that both sets of frequency resources satisfy the threshold.

At 725, the UE 115-b may transmit a first uplink message to the first network entity 105-c using the first set of frequency resources according to the first beam configuration (e.g., first TCI state, first antenna panel, first SCI, etc.). At 730, the UE 115-b may transmit a second uplink message using a second set of frequency resources according to the second beam configuration (e.g., second TCI state, a second antenna panel, second SCI, etc.). The second number of frequency resources (e.g., of the second set of frequency resources) may satisfy a threshold (e.g., a second transform precoding threshold number of frequency resources). For example, the second set of frequency resources may satisfy M_{RB}^{PUSCH}=2·2^{α}^{₂}3^{α}^{₃}5^{α}^{₅}, or

$$⌊ \frac{{n}_{P R B}}{2} ⌋ = {2}^{{α}_{2}} {3}^{{α}_{3}} {5}^{{α}_{5}} .$$

As such, the first set of frequency resources and the second set of frequency resources may satisfy a threshold, and may support transform precoding.

At 715, the UE 115-b may determine the first set of frequency resources and the second set of frequency resources based on the FDRA received at 710. For example, the UE 115-b may receive, in the FDRA (e.g., at 710), an indication of a single set of frequency resources (e.g., the first set of frequency resources). The UE 115-b may extend the first set of frequency resources in the frequency domain to identify the second set of frequency resources, as described in greater detail with reference to FIG. 4. In such examples, the first number of frequency resources in the first set of frequency resources may be equal to the second number of frequency resources in the second set of frequency resources. Both the first set of frequency resources and the second set of frequency resources may satisfy the threshold, and the transform precoding threshold number of frequency resources may be the same for each of the two sets of frequency resources.

In some examples, the UE 115-b may receive, in the FDRA field of the DCI at 710, an indication of multiple frequency resources that includes both the first set of frequency resources and the second set of frequency resources. In such examples, at 715, the UE 115-b may divide the multiple frequency resources into a first portion including the first set of frequency resources and a second portion including the second set of frequency resources, as described in greater detail with reference to FIG. 5. In such examples, the first number of frequency resources may be equal to the second number of frequency resources. The multiple frequency resources indicated by the DCI message may satisfy a threshold value equal to a sum of a first transform precoding threshold number of frequency resources and a second transform precoding threshold number of frequency resources (e.g., M_{RB}^{PUSCH}=2·2^{α}^{₂}3^{α}^{₃}5^{α}^{₅} as for the multiple frequency resources). In such examples, each of the two sets of frequency resources may satisfy M_{RB}^{PUSCH}=2·2^{α}^{₂}3^{α}^{₃}5^{α}^{₅}, and α₂, α₃ and α₅ may be the same for each set of frequency resources.

In some examples, the UE 115-b may the UE 115-b may receive, in the FDRA field of the DCI at 710, an indication of multiple frequency resources that includes both the first set of frequency resources and the second set of frequency resources. In such examples, at 715, the UE 115-b may divide the multiple frequency resources, according to a flooring or ceiling procedure, into a first portion including the first set of frequency resources and a second portion including the second set of frequency resources, as described in greater detail with reference to FIG. 6. In such examples, the first number of frequency resources may be different than the second set of frequency resources. The first transform precoding threshold number of frequency resources

$$⌈ \frac{{n}_{P R B}}{2} ⌉ = {2}^{{α}_{2}} {3}^{{α}_{3}} {5}^{{α}_{5}}$$

may be different from the second set of frequency resources

$$⌊ \frac{{n}_{P R B}}{2} ⌋ = {2}^{{α}_{2}^{′}} {3}^{{α}_{3}^{′}} {5}^{{α}_{5}^{′}} .$$

In some examples, α₂, α₃ and α₅ for the first set of frequency resources may be different from α′₂, α′₃ and α′₅, for the second set of frequency resources.

Having identified the two sets of frequency resources for the first beam configuration and the second beam configuration, at 720, the UE 115-b may perform transform precoding (e.g., based on the first and second sets of frequency resources satisfying the transform precoding threshold number of frequency resources). The UE 115-b may transmit the first uplink message at 725 and the second uplink message at 730 based on having transform precoded both the first uplink message and the second uplink message, as described with reference to FIG. 3.

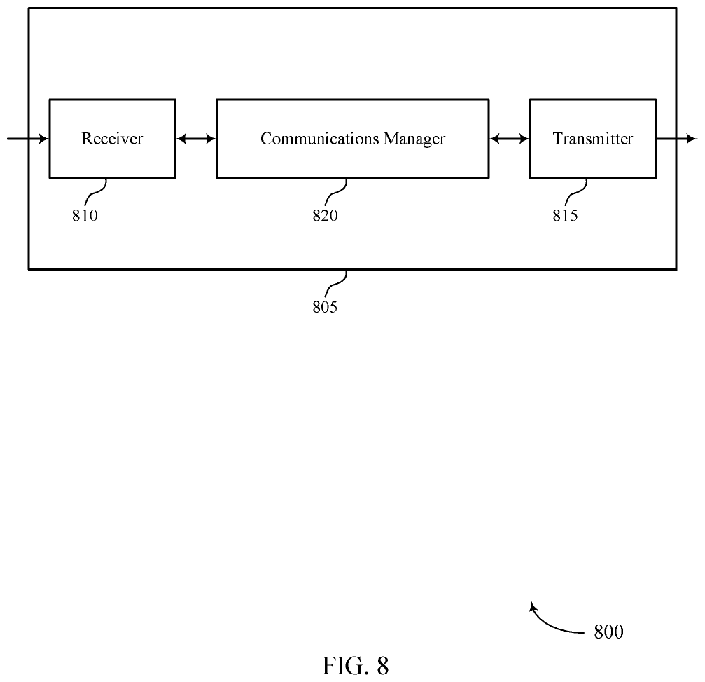

FIG. 8 shows a block diagram 800 of a device 805 that supports frequency domain resource allocation indications for transform precoding in multiple transmit receive point deployments in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to frequency domain resource allocation indications for transform precoding in multiple transmit receive point deployments). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to frequency domain resource allocation indications for transform precoding in multiple transmit receive point deployments). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of frequency domain resource allocation indications for transform precoding in multiple transmit receive point deployments as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. For example, the communications manager 820 may be configured as or otherwise support a means for receiving an indication of a configuration of a first beam configuration and a second beam configuration. The communications manager 820 may be configured as or otherwise support a means for receiving a downlink control information message including a frequency domain resource allocation field indicating a first set of frequency resources associated with the first beam configuration, where a first number of frequency resources in the first set of frequency resources satisfies a first transform precoding threshold number of frequency resources. The communications manager 820 may be configured as or otherwise support a means for transmitting a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for wireless signaling and resource allocation resulting in reliable transform precoding, increased reliability of uplink signaling, more efficient use of available communication resources, decreased system latency, and improved user experience, among other examples.

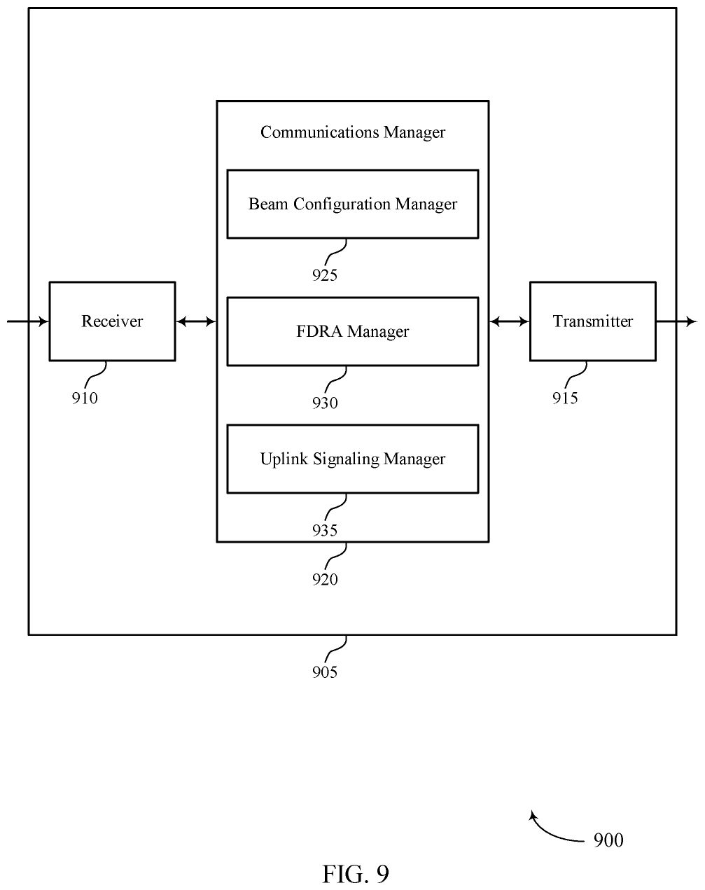

FIG. 9 shows a block diagram 900 of a device 905 that supports frequency domain resource allocation indications for transform precoding in multiple transmit receive point deployments in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to frequency domain resource allocation indications for transform precoding in multiple transmit receive point deployments). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to frequency domain resource allocation indications for transform precoding in multiple transmit receive point deployments). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of frequency domain resource allocation indications for transform precoding in multiple transmit receive point deployments as described herein. For example, the communications manager 920 may include a beam configuration manager 925, an FDRA manager 930, an uplink signaling manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. The beam configuration manager 925 may be configured as or otherwise support a means for receiving an indication of a configuration of a first beam configuration and a second beam configuration. The FDRA manager 930 may be configured as or otherwise support a means for receiving a downlink control information message including a frequency domain resource allocation field indicating a first set of frequency resources associated with the first beam configuration, where a first number of frequency resources in the first set of frequency resources satisfies a first transform precoding threshold number of frequency resources. The uplink signaling manager 935 may be configured as or otherwise support a means for transmitting a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

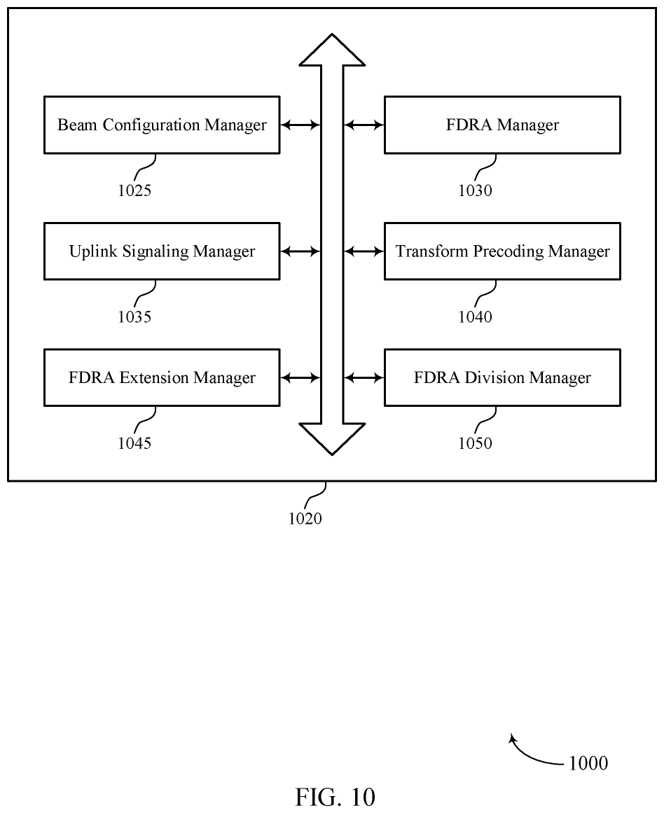

FIG. 10 shows a block diagram 1000 of a communications manager 1020 that supports frequency domain resource allocation indications for transform precoding in multiple transmit receive point deployments in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of frequency domain resource allocation indications for transform precoding in multiple transmit receive point deployments as described herein. For example, the communications manager 1020 may include a beam configuration manager 1025, an FDRA manager 1030, an uplink signaling manager 1035, a transform precoding manager 1040, an FDRA extension manager 1045, an FDRA division manager 1050, or any combination thereof. Each of these components may communicate, directly or indirectly, with one another (e.g., via one or more buses).

The communications manager 1020 may support wireless communications at a UE in accordance with examples as disclosed herein. The beam configuration manager 1025 may be configured as or otherwise support a means for receiving an indication of a configuration of a first beam configuration and a second beam configuration. The FDRA manager 1030 may be configured as or otherwise support a means for receiving a downlink control information message including a frequency domain resource allocation field indicating a first set of frequency resources associated with the first beam configuration, where a first number of frequency resources in the first set of frequency resources satisfies a first transform precoding threshold number of frequency resources. The uplink signaling manager 1035 may be configured as or otherwise support a means for transmitting a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

In some examples, the transform precoding manager 1040 may be configured as or otherwise support a means for transform precoding the first uplink message based on the first number of frequency resources satisfying the first transform precoding threshold number of frequency resources, where transmitting the first uplink message is based on transform precoding the first uplink message. In some examples, the transform precoding manager 1040 may be configured as or otherwise support a means for transform precoding the second uplink message based on the second number of frequency resources satisfying the second transform precoding threshold number of frequency resources, where transmitting the second uplink message is based on transform precoding the second uplink message.

In some examples, the FDRA extension manager 1045 may be configured as or otherwise support a means for extending the first set of frequency resources in the frequency domain to identify the second set of frequency resources, where the first number of frequency resources is equal to the second number of frequency resources.

In some examples, the first transform precoding threshold number of frequency resources is equal to the second transform precoding threshold number of frequency resources.

In some examples, the FDRA division manager 1050 may be configured as or otherwise support a means for receiving, in the frequency domain resource allocation field, a single indication of a set of multiple frequency resources including the first set of frequency resources and the second set of frequency resources.

In some examples, the FDRA division manager 1050 may be configured as or otherwise support a means for dividing the set of multiple frequency resources into a first portion including the first set of frequency resources and a second portion including the second set of frequency resources, where the first number of frequency resources is equal to the second number of frequency resources.

In some examples, the set of multiple frequency resources satisfies a threshold value equal to a sum of the first transform precoding threshold number of frequency resources and the second transform precoding threshold number of frequency resources.

In some examples, the first transform precoding threshold number of frequency resources is equal to the second transform precoding threshold number of frequency resources.

In some examples, the FDRA division manager 1050 may be configured as or otherwise support a means for dividing, according to a flooring or ceiling procedure, the set of multiple frequency resources into a first portion including the first set of frequency resources and a second portion including the second set of frequency resources, where the first number of frequency resources is different from the second number of frequency resources.

In some examples, the first transform precoding threshold number of frequency resources is different from the second transform precoding threshold number of frequency resources.

In some examples, to support transmitting the first uplink message and the second uplink message, the uplink signaling manager 1035 may be configured as or otherwise support a means for transmitting the first uplink message via a first antenna panel to a first transmit/receive point in a multiple transmit/receive point deployment. In some examples, to support transmitting the first uplink message and the second uplink message, the uplink signaling manager 1035 may be configured as or otherwise support a means for transmitting the second uplink message via a second antenna panel to a second transmit/receive point in the multiple transmit/receive point deployment.

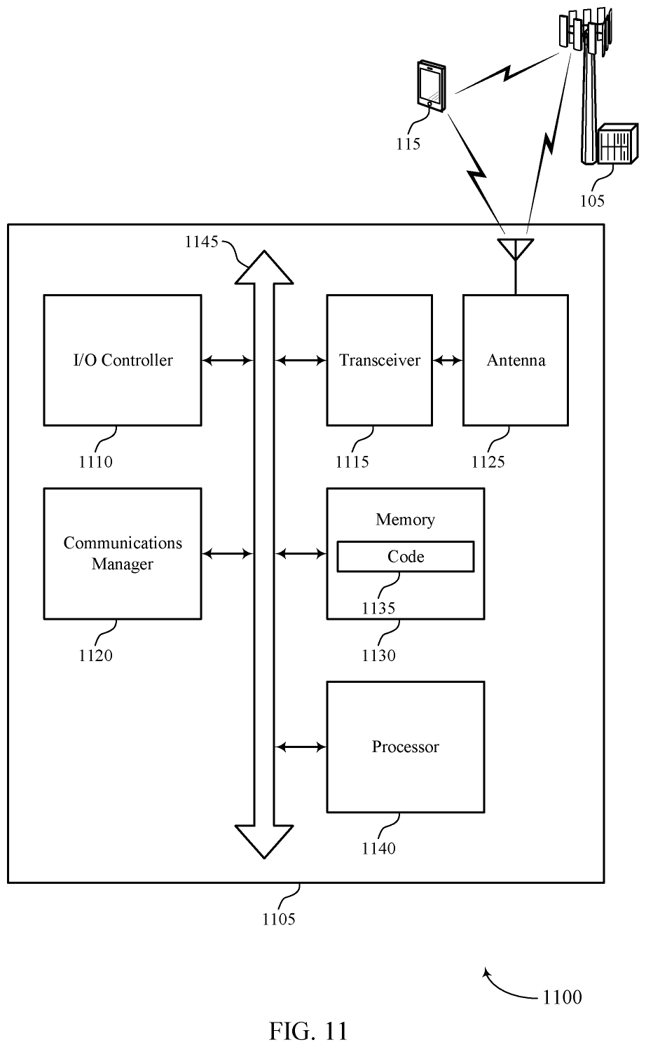

FIG. 11 shows a diagram of a system 1100 including a device 1105 that supports frequency domain resource allocation indications for transform precoding in multiple transmit receive point deployments in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting frequency domain resource allocation indications for transform precoding in multiple transmit receive point deployments). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communications at a UE in accordance with examples as disclosed herein. For example, the communications manager 1120 may be configured as or otherwise support a means for receiving an indication of a configuration of a first beam configuration and a second beam configuration. The communications manager 1120 may be configured as or otherwise support a means for receiving a downlink control information message including a frequency domain resource allocation field indicating a first set of frequency resources associated with the first beam configuration, where a first number of frequency resources in the first set of frequency resources satisfies a first transform precoding threshold number of frequency resources. The communications manager 1120 may be configured as or otherwise support a means for transmitting a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

By including or configuring the communications manager 1120 in accordance with examples as described herein, the device 1105 may support techniques for wireless signaling and resource allocation resulting in reliable transform precoding, increased reliability of uplink signaling, more efficient use of available communication resources, decreased system latency, and improved user experience, among other examples.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of frequency domain resource allocation indications for transform precoding in multiple transmit receive point deployments as described herein, or the processor 1140 and the memory 1130 may be otherwise configured to perform or support such operations.

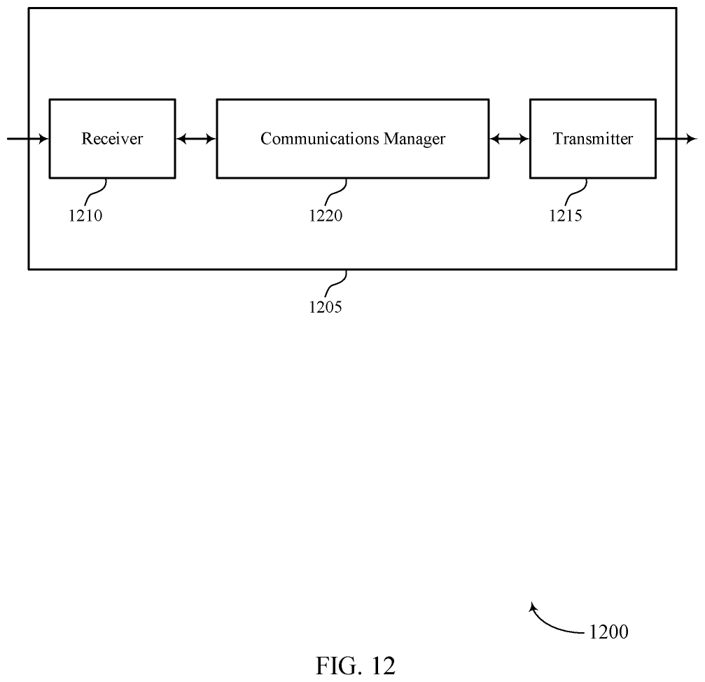

FIG. 12 shows a block diagram 1200 of a device 1205 that supports frequency domain resource allocation indications for transform precoding in multiple transmit receive point deployments in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of frequency domain resource allocation indications for transform precoding in multiple transmit receive point deployments as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. For example, the communications manager 1220 may be configured as or otherwise support a means for transmitting an indication of a configuration of a first beam configuration and a second beam configuration. The communications manager 1220 may be configured as or otherwise support a means for transmitting a downlink control information message including a frequency domain resource allocation field indicating a first set of frequency resources associated with the first beam configuration, where a first number of frequency resources in the first set of frequency resources satisfies a first transform precoding threshold number of frequency resources. The communications manager 1220 may be configured as or otherwise support a means for receiving a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for wireless signaling and resource allocation resulting in reliable transform precoding, increased reliability of uplink signaling, more efficient use of available communication resources, decreased system latency, and improved user experience, among other examples.

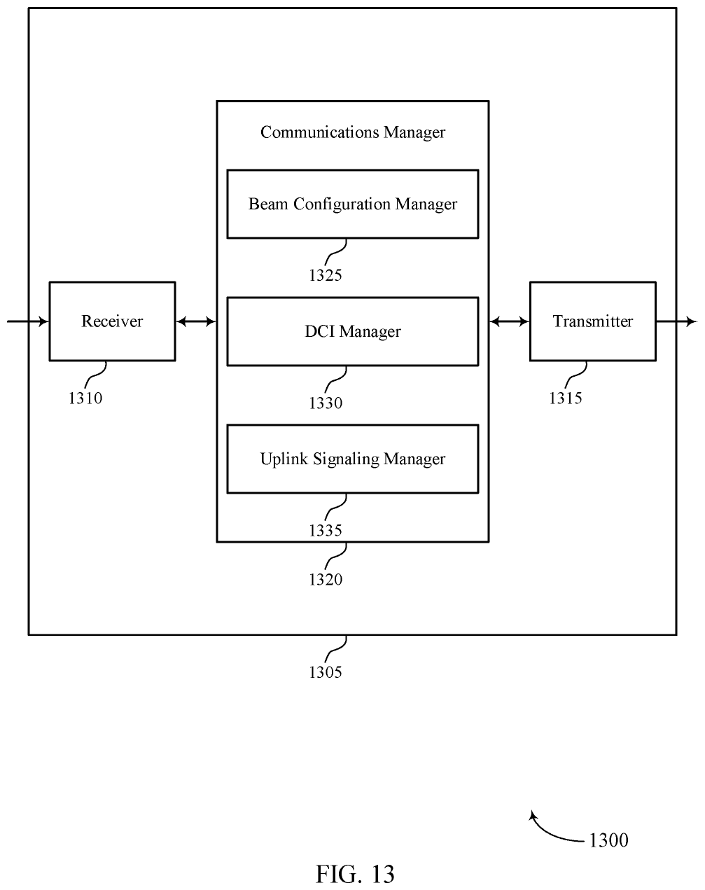

FIG. 13 shows a block diagram 1300 of a device 1305 that supports frequency domain resource allocation indications for transform precoding in multiple transmit receive point deployments in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of frequency domain resource allocation indications for transform precoding in multiple transmit receive point deployments as described herein. For example, the communications manager 1320 may include a beam configuration manager 1325, a DCI manager 1330, an uplink signaling manager 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a network entity in accordance with examples as disclosed herein. The beam configuration manager 1325 may be configured as or otherwise support a means for transmitting an indication of a configuration of a first beam configuration and a second beam configuration. The DCI manager 1330 may be configured as or otherwise support a means for transmitting a downlink control information message including a frequency domain resource allocation field indicating a first set of frequency resources associated with the first beam configuration, where a first number of frequency resources in the first set of frequency resources satisfies a first transform precoding threshold number of frequency resources. The uplink signaling manager 1335 may be configured as or otherwise support a means for receiving a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

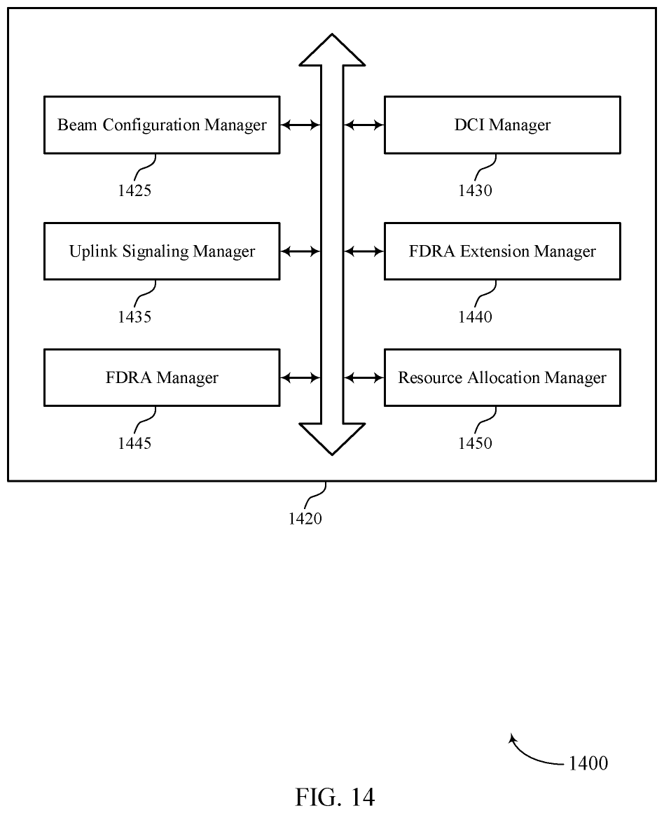

FIG. 14 shows a block diagram 1400 of a communications manager 1420 that supports frequency domain resource allocation indications for transform precoding in multiple transmit receive point deployments in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of frequency domain resource allocation indications for transform precoding in multiple transmit receive point deployments as described herein. For example, the communications manager 1420 may include a beam configuration manager 1425, a DCI manager 1430, an uplink signaling manager 1435, an FDRA extension manager 1440, an FDRA manager 1445, a resource allocation manager 1450, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications at a network entity in accordance with examples as disclosed herein. The beam configuration manager 1425 may be configured as or otherwise support a means for transmitting an indication of a configuration of a first beam configuration and a second beam configuration. The DCI manager 1430 may be configured as or otherwise support a means for transmitting a downlink control information message including a frequency domain resource allocation field indicating a first set of frequency resources associated with the first beam configuration, where a first number of frequency resources in the first set of frequency resources satisfies a first transform precoding threshold number of frequency resources. The uplink signaling manager 1435 may be configured as or otherwise support a means for receiving a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

In some examples, the FDRA extension manager 1440 may be configured as or otherwise support a means for extending the first set of frequency resources in the frequency domain to identify the second set of frequency resources, where the first number of frequency resources is equal to the second number of frequency resources.

In some examples, the first transform precoding threshold number of frequency resources is equal to the second transform precoding threshold number of frequency resources.

In some examples, the FDRA manager 1445 may be configured as or otherwise support a means for transmitting, in the frequency domain resource allocation field, a single indication of a set of multiple frequency resources including the first set of frequency resources and the second set of frequency resources.

In some examples, the resource allocation manager 1450 may be configured as or otherwise support a means for allocating a first portion of the set of multiple frequency resources including the first set of frequency resources for the first beam configuration and a second portion of the set of multiple frequency resources including the second set of frequency resources for the second beam configuration, where the first number of frequency resources is equal to the second number of frequency resources.

In some examples, the set of multiple frequency resources satisfies a threshold value equal to a sum of the first transform precoding threshold number of frequency resources and the second transform precoding threshold number of frequency resources.

In some examples, the first transform precoding threshold number of frequency resources is equal to the second transform precoding threshold number of frequency resources.

In some examples, the resource allocation manager 1450 may be configured as or otherwise support a means for allocating, according to a flooring or ceiling procedure, the set of multiple frequency resources into a first portion including the first set of frequency resources and a second portion including the second set of frequency resources, where the first number of frequency resources is different from the second number of frequency resources.

In some examples, the first transform precoding threshold number of frequency resources is different from the second transform precoding threshold number of frequency resources.

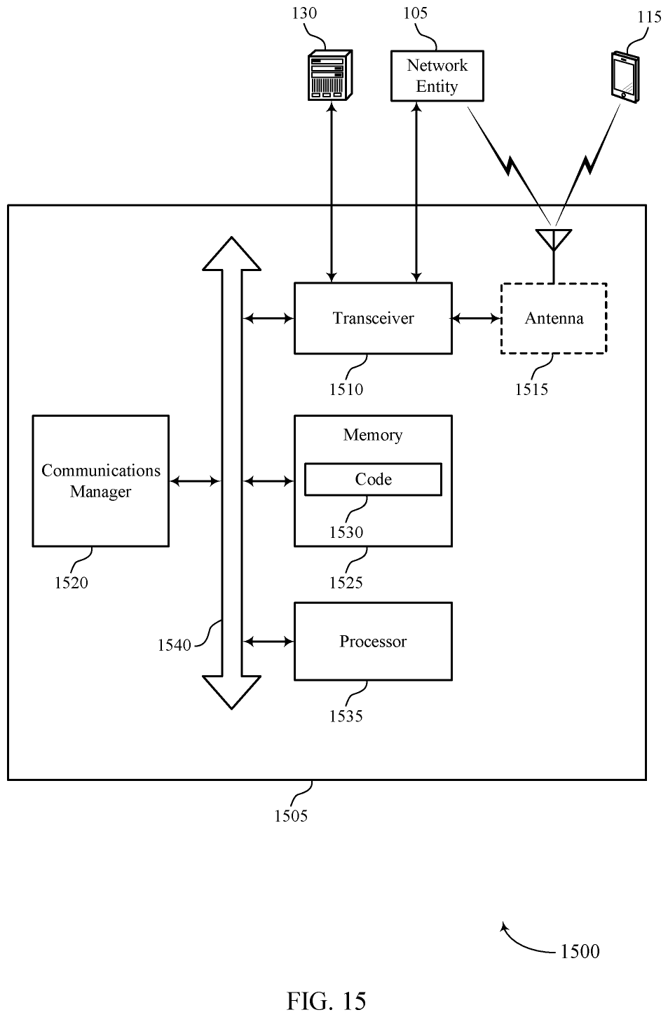

FIG. 15 shows a diagram of a system 1500 including a device 1505 that supports frequency domain resource allocation indications for transform precoding in multiple transmit receive point deployments in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. The transceiver 1510, or the transceiver 1510 and one or more antennas 1515 or wired interfaces, where applicable, may be an example of a transmitter 1215, a transmitter 1315, a receiver 1210, a receiver 1310, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting frequency domain resource allocation indications for transform precoding in multiple transmit receive point deployments). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communications at a network entity in accordance with examples as disclosed herein. For example, the communications manager 1520 may be configured as or otherwise support a means for transmitting an indication of a configuration of a first beam configuration and a second beam configuration. The communications manager 1520 may be configured as or otherwise support a means for transmitting a downlink control information message including a frequency domain resource allocation field indicating a first set of frequency resources associated with the first beam configuration, where a first number of frequency resources in the first set of frequency resources satisfies a first transform precoding threshold number of frequency resources. The communications manager 1520 may be configured as or otherwise support a means for receiving a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources.

By including or configuring the communications manager 1520 in accordance with examples as described herein, the device 1505 may support techniques for wireless signaling and resource allocation resulting in reliable transform precoding, increased reliability of uplink signaling, more efficient use of available communication resources, decreased system latency, and improved user experience, among other examples.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the processor 1535, the memory 1525, the code 1530, the transceiver 1510, or any combination thereof. For example, the code 1530 may include instructions executable by the processor 1535 to cause the device 1505 to perform various aspects of frequency domain resource allocation indications for transform precoding in multiple transmit receive point deployments as described herein, or the processor 1535 and the memory 1525 may be otherwise configured to perform or support such operations.

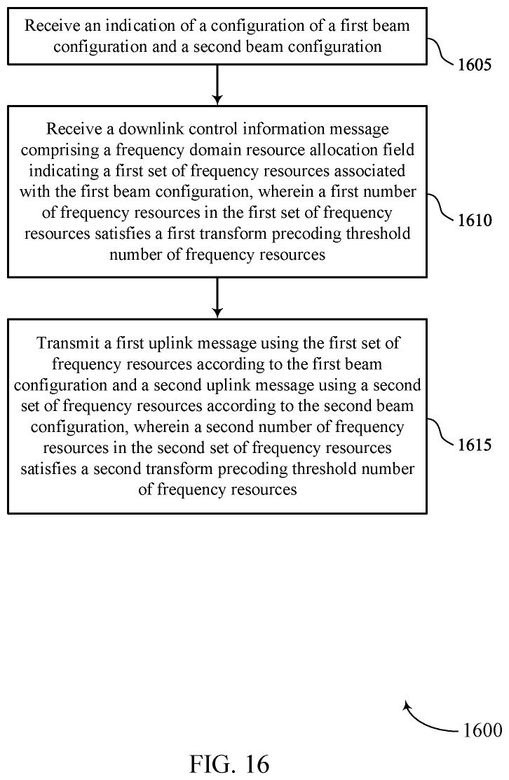

FIG. 16 shows a flowchart illustrating a method 1600 that supports frequency domain resource allocation indications for transform precoding in multiple transmit receive point deployments in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving an indication of a configuration of a first beam configuration and a second beam configuration. The operations of 1605 may be performed in accordance with examples as disclosed herein. In some examples, aspects of the operations of 1605 may be performed by a beam configuration manager 1025 as described with reference to FIG. 10.

At 1610, the method may include receiving a downlink control information message including a frequency domain resource allocation field indicating a first set of frequency resources associated with the first beam configuration, where a first number of frequency resources in the first set of frequency resources satisfies a first transform precoding threshold number of frequency resources. The operations of 1610 may be performed in accordance with examples as disclosed herein. In some examples, aspects of the operations of 1610 may be performed by an FDRA manager 1030 as described with reference to FIG. 10.

At 1615, the method may include transmitting a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources. The operations of 1615 may be performed in accordance with examples as disclosed herein. In some examples, aspects of the operations of 1615 may be performed by an uplink signaling manager 1035 as described with reference to FIG. 10.

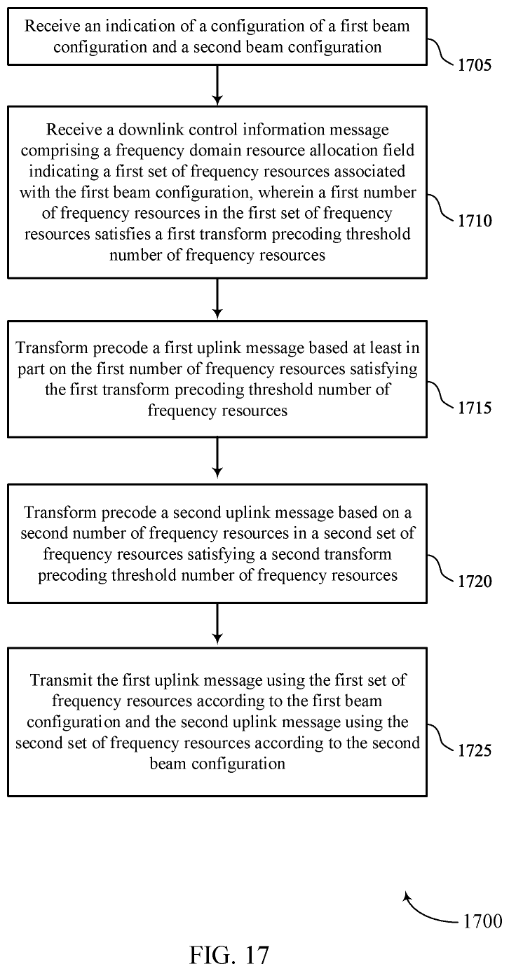

FIG. 17 shows a flowchart illustrating a method 1700 that supports frequency domain resource allocation indications for transform precoding in multiple transmit receive point deployments in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving an indication of a configuration of a first beam configuration and a second beam configuration. The operations of 1705 may be performed in accordance with examples as disclosed herein. In some examples, aspects of the operations of 1705 may be performed by a beam configuration manager 1025 as described with reference to FIG. 10.

At 1710, the method may include receiving a downlink control information message including a frequency domain resource allocation field indicating a first set of frequency resources associated with the first beam configuration, where a first number of frequency resources in the first set of frequency resources satisfies a first transform precoding threshold number of frequency resources. The operations of 1710 may be performed in accordance with examples as disclosed herein. In some examples, aspects of the operations of 1710 may be performed by an FDRA manager 1030 as described with reference to FIG. 10.

At 1715, the method may include transform precoding a first uplink message based on the first number of frequency resources satisfying the first transform precoding threshold number of frequency resources. The operations of 1715 may be performed in accordance with examples as disclosed herein. In some examples, aspects of the operations of 1715 may be performed by a transform precoding manager 1040 as described with reference to FIG. 10.

At 1720, the method may include transform precoding a second uplink message based on a second number of frequency resources in a second set of frequency resources satisfying a second transform precoding threshold number of frequency resources. The operations of 1720 may be performed in accordance with examples as disclosed herein. In some examples, aspects of the operations of 1720 may be performed by a transform precoding manager 1040 as described with reference to FIG. 10.

At 1725, the method may include transmitting the first uplink message using the first set of frequency resources according to the first beam configuration and the second uplink message using the second set of frequency resources according to the second beam configuration. The operations of 1725 may be performed in accordance with examples as disclosed herein. In some examples, aspects of the operations of 1725 may be performed by an uplink signaling manager 1035 as described with reference to FIG. 10.

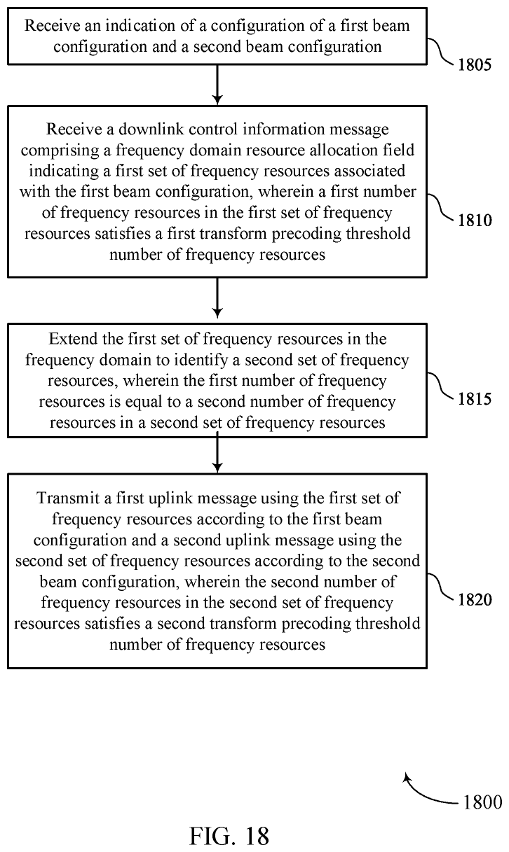

FIG. 18 shows a flowchart illustrating a method 1800 that supports frequency domain resource allocation indications for transform precoding in multiple transmit receive point deployments in accordance with one or more aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include receiving an indication of a configuration of a first beam configuration and a second beam configuration. The operations of 1805 may be performed in accordance with examples as disclosed herein. In some examples, aspects of the operations of 1805 may be performed by a beam configuration manager 1025 as described with reference to FIG. 10.

At 1810, the method may include receiving a downlink control information message including a frequency domain resource allocation field indicating a first set of frequency resources associated with the first beam configuration, where a first number of frequency resources in the first set of frequency resources satisfies a first transform precoding threshold number of frequency resources. The operations of 1810 may be performed in accordance with examples as disclosed herein. In some examples, aspects of the operations of 1810 may be performed by an FDRA manager 1030 as described with reference to FIG. 10.

At 1815, the method may include extending the first set of frequency resources in the frequency domain to identify a second set of frequency resources, wherein the first number of frequency resources is equal to a second number of frequency resources in a second set of frequency resources. The operations of 1815 may be performed in accordance with examples as disclosed herein. In some examples, aspects of the operations of 1815 may be performed by an FDRA extension manager 1045 as described with reference to FIG. 10.

At 1820, the method may include transmitting a first uplink message using the first set of frequency resources according to the first beam configuration and a second uplink message using the second set of frequency resources according to the second beam configuration, wherein the second number of frequency resources in the second set of frequency resources satisfies a second transform precoding threshold number of frequency resources. The operations of 1820 may be performed in accordance with examples as disclosed herein. In some examples, aspects of the operations of 1820 may be performed by an uplink signaling manager 1035 as described with reference to FIG. 10.

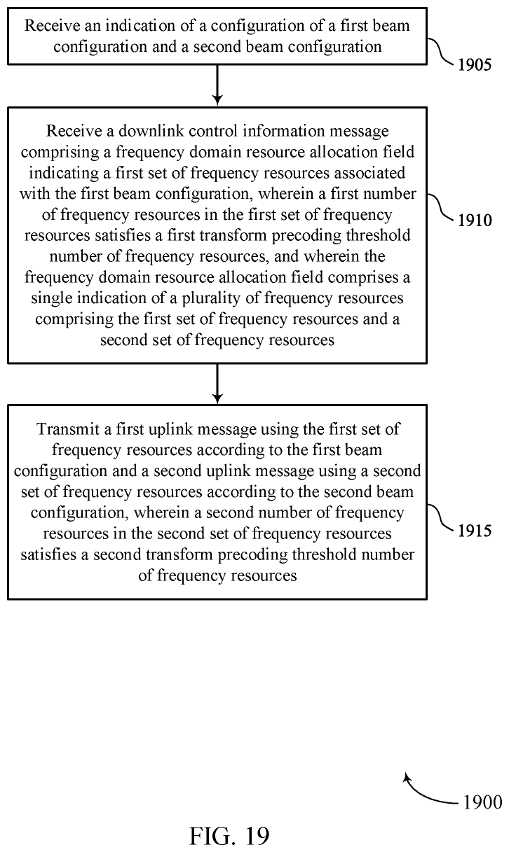

FIG. 19 shows a flowchart illustrating a method 1900 that supports frequency domain resource allocation indications for transform precoding in multiple transmit receive point deployments in accordance with one or more aspects of the present disclosure. The operations of the method 1900 may be implemented by a UE or its components as described herein. For example, the operations of the method 1900 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1905, the method may include receiving an indication of a configuration of a first beam configuration and a second beam configuration. The operations of 1905 may be performed in accordance with examples as disclosed herein. In some examples, aspects of the operations of 1905 may be performed by a beam configuration manager 1025 as described with reference to FIG. 10.

At 1910, the method may include a downlink control information message comprising a frequency domain resource allocation field indicating a first set of frequency resources associated with the first beam configuration, wherein a first number of frequency resources in the first set of frequency resources satisfies a first transform precoding threshold number of frequency resources, and wherein the frequency domain resource allocation field comprises a single indication of a plurality of frequency resources comprising the first set of frequency resources and a second set of frequency resources. The operations of 1910 may be performed in accordance with examples as disclosed herein. In some examples, aspects of the operations of 1910 may be performed by an FDRA manager 1030 as described with reference to FIG. 10.

At 1915, the method may include transmitting a first uplink message using the first set of frequency resources according to the first beam configuration and a second uplink message using a second set of frequency resources according to the second beam configuration, wherein a second number of frequency resources in the second set of frequency resources satisfies a second transform precoding threshold number of frequency resources. The operations of 1915 may be performed in accordance with examples as disclosed herein. In some examples, aspects of the operations of 1915 may be performed by an uplink signaling manager 1035 as described with reference to FIG. 10.

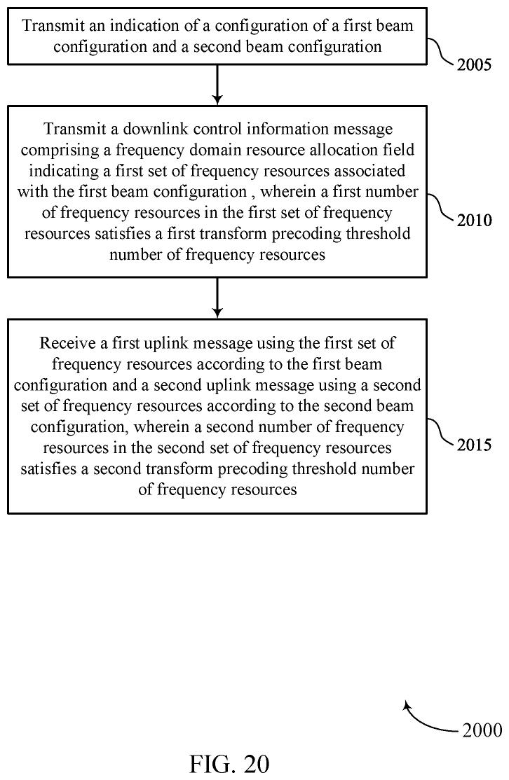

FIG. 20 shows a flowchart illustrating a method 2000 that supports frequency domain resource allocation indications for transform precoding in multiple transmit receive point deployments in accordance with one or more aspects of the present disclosure. The operations of the method 2000 may be implemented by a network entity or its components as described herein. For example, the operations of the method 2000 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2005, the method may include transmitting an indication of a configuration of a first beam configuration and a second beam configuration. The operations of 2005 may be performed in accordance with examples as disclosed herein. In some examples, aspects of the operations of 2005 may be performed by a beam configuration manager 1425 as described with reference to FIG. 14.

At 2010, the method may include transmitting a downlink control information message including a frequency domain resource allocation field indicating a first set of frequency resources associated with the first beam configuration, where a first number of frequency resources in the first set of frequency resources satisfies a first transform precoding threshold number of frequency resources. The operations of 2010 may be performed in accordance with examples as disclosed herein. In some examples, aspects of the operations of 2010 may be performed by a DCI manager 1430 as described with reference to FIG. 14.

At 2015, the method may include receiving a first uplink message using the first set of frequency resources according to the first beam configuration and a second uplink message using a second set of frequency resources according to the second beam configuration, where a second number of frequency resources in the second set of frequency resources satisfies a second transform precoding threshold number of frequency resources. The operations of 2015 may be performed in accordance with examples as disclosed herein. In some examples, aspects of the operations of 2015 may be performed by an uplink signaling manager 1435 as described with reference to FIG. 14.

The following provides an overview of aspects of the present disclosure:

Aspect 1: A method for wireless communications at a UE, comprising: receiving an indication of a configuration of a first beam configuration and a second beam configuration; receiving a downlink control information message comprising a frequency domain resource allocation field indicating a first set of frequency resources associated with the first beam configuration, wherein a first number of frequency resources in the first set of frequency resources satisfies a first transform precoding threshold number of frequency resources; and transmitting a first uplink message using the first set of frequency resources according to the first beam configuration and a second uplink message using a second set of frequency resources according to the second beam configuration, wherein a second number of frequency resources in the second set of frequency resources satisfies a second transform precoding threshold number of frequency resources.

Aspect 2: The method of aspect 1, further comprising: transform precoding the first uplink message based at least in part on the first number of frequency resources satisfying the first transform precoding threshold number of frequency resources, wherein transmitting the first uplink message is based at least in part on transform precoding the first uplink message; and transform precoding the second uplink message based at least in part on the second number of frequency resources satisfying the second transform precoding threshold number of frequency resources, wherein transmitting the second uplink message is based at least in part on transform precoding the second uplink message.

Aspect 3: The method of any of aspects 1 through 2, further comprising: extending the first set of frequency resources in the frequency domain to identify the second set of frequency resources, wherein the first number of frequency resources is equal to the second number of frequency resources.

Aspect 4: The method of aspect 3, wherein the first transform precoding threshold number of frequency resources is equal to the second transform precoding threshold number of frequency resources.

Aspect 5: The method of any of aspects 1 through 4, further comprising: receiving, in the frequency domain resource allocation field, a single indication of a plurality of frequency resources comprising the first set of frequency resources and the second set of frequency resources.

Aspect 6: The method of aspect 5, further comprising: dividing the plurality of frequency resources into a first portion comprising the first set of frequency resources and a second portion comprising the second set of frequency resources, wherein the first number of frequency resources is equal to the second number of frequency resources.

Aspect 7: The method of aspect 6, wherein the plurality of frequency resources satisfies a threshold value equal to a sum of the first transform precoding threshold number of frequency resources and the second transform precoding threshold number of frequency resources.

Aspect 8: The method of any of aspects 6 through 7, wherein the first transform precoding threshold number of frequency resources is equal to the second transform precoding threshold number of frequency resources.

Aspect 9: The method of any of aspects 5 through 8, further comprising: dividing, according to a flooring procedure, the plurality of frequency resources into a first portion comprising the first set of frequency resources and a second portion comprising the second set of frequency resources, wherein the first number of frequency resources is different from the second number of frequency resources.

Aspect 10: The method of aspect 9, wherein the first transform precoding threshold number of frequency resources is different from the second transform precoding threshold number of frequency resources.

Aspect 11: The method of any of aspects 1 through 10, wherein transmitting the first uplink message and the second uplink message comprises: transmitting the first uplink message via a first antenna panel to a first transmit/receive point in a multiple transmit/receive point deployment; and transmitting the second uplink message via a second antenna panel to a second transmit/receive point in the multiple transmit/receive point deployment.

Aspect 12: A method for wireless communications at a network entity, comprising: transmitting an indication of a configuration of a first beam configuration and a second beam configuration; transmitting a downlink control information message comprising a frequency domain resource allocation field indicating a first set of frequency resources associated with the first beam configuration, wherein a first number of frequency resources in the first set of frequency resources satisfies a first transform precoding threshold number of frequency resources; and receiving a first uplink message using the first set of frequency resources according to the first beam configuration and a second uplink message using a second set of frequency resources according to the second beam configuration, wherein a second number of frequency resources in the second set of frequency resources satisfies a second transform precoding threshold number of frequency resources.

Aspect 13: The method of aspect 12, further comprising: extending the first set of frequency resources in the frequency domain to identify the second set of frequency resources, wherein the first number of frequency resources is equal to the second number of frequency resources.

Aspect 14: The method of aspect 13, wherein the first transform precoding threshold number of frequency resources is equal to the second transform precoding threshold number of frequency resources.

Aspect 15: The method of any of aspects 12 through 14, further comprising: transmitting, in the frequency domain resource allocation field, a single indication of a plurality of frequency resources comprising the first set of frequency resources and the second set of frequency resources.

Aspect 16: The method of aspect 15, further comprising: allocating a first portion of the plurality of frequency resources comprising the first set of frequency resources for the first beam configuration and a second portion of the plurality of frequency resources comprising the second set of frequency resources for the second beam configuration, wherein the first number of frequency resources is equal to the second number of frequency resources.

Aspect 17: The method of aspect 16, wherein the plurality of frequency resources satisfies a threshold value equal to a sum of the first transform precoding threshold number of frequency resources and the second transform precoding threshold number of frequency resources.

Aspect 18: The method of any of aspects 16 through 17, wherein the first transform precoding threshold number of frequency resources is equal to the second transform precoding threshold number of frequency resources.

Aspect 19: The method of any of aspects 15 through 18, further comprising: allocating, according to a flooring procedure, the plurality of frequency resources into a first portion comprising the first set of frequency resources and a second portion comprising the second set of frequency resources, wherein the first number of frequency resources is different from the second number of frequency resources.

Aspect 20: The method of aspect 19, wherein the first transform precoding threshold number of frequency resources is different from the second transform precoding threshold number of frequency resources.

Aspect 21: An apparatus for wireless communications at a UE, comprising a processor; memory coupled with the processor; and instructions stored in the memory and executable by the processor to cause the apparatus to perform a method of any of aspects 1 through 11.

Aspect 22: An apparatus for wireless communications at a UE, comprising at least one means for performing a method of any of aspects 1 through 11.

Aspect 23: A non-transitory computer-readable medium storing code for wireless communications at a UE, the code comprising instructions executable by a processor to perform a method of any of aspects 1 through 11.

Aspect 24: An apparatus for wireless communications at a network entity, comprising a processor; memory coupled with the processor; and instructions stored in the memory and executable by the processor to cause the apparatus to perform a method of any of aspects 12 through 20.

Aspect 25: An apparatus for wireless communications at a network entity, comprising at least one means for performing a method of any of aspects 12 through 20.

Aspect 26: A non-transitory computer-readable medium storing code for wireless communications at a network entity, the code comprising instructions executable by a processor to perform a method of any of aspects 12 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory in electronic communication with the processor; and
instructions stored in the memory wherein the instructions are executable by the processor to:
receive an indication of a configuration of a first beam configuration and a second beam configuration;
receive a downlink control information message comprising a frequency domain resource allocation field indicating a first set of frequency resources associated with the first beam configuration, wherein a first number of frequency resources in the first set of frequency resources satisfies a first transform precoding threshold number of frequency resources; and
transmit a first uplink message using the first set of frequency resources according to the first beam configuration and a second uplink message using a second set of frequency resources according to the second beam configuration, wherein a second number of frequency resources in the second set of frequency resources satisfies a second transform precoding threshold number of frequency resources.

2. The apparatus of claim 1, wherein the instructions are further executable by the processor to:
transform precode the first uplink message based at least in part on the first number of frequency resources satisfying the first transform precoding threshold number of frequency resources, wherein transmitting the first uplink message is based at least in part on transform precoding the first uplink message; and
transform precode the second uplink message based at least in part on the second number of frequency resources satisfying the second transform precoding threshold number of frequency resources, wherein transmitting the second uplink message is based at least in part on transform precoding the second uplink message.

3. The apparatus of claim 1, wherein the instructions are further executable by the processor to:
extend the first set of frequency resources in the frequency domain to identify the second set of frequency resources, wherein the first number of frequency resources is equal to the second number of frequency resources.

4. The apparatus of claim 3, wherein the first transform precoding threshold number of frequency resources is equal to the second transform precoding threshold number of frequency resources.

5. The apparatus of claim 1, wherein the instructions are further executable by the processor to:
receive, in the frequency domain resource allocation field, a single indication of a plurality of frequency resources comprising the first set of frequency resources and the second set of frequency resources.

6. The apparatus of claim 5, wherein the instructions are further executable by the processor to:
divide the plurality of frequency resources into a first portion comprising the first set of frequency resources and a second portion comprising the second set of frequency resources, wherein the first number of frequency resources is equal to the second number of frequency resources.

7. The apparatus of claim 6, wherein the plurality of frequency resources satisfies a threshold value equal to a sum of the first transform precoding threshold number of frequency resources and the second transform precoding threshold number of frequency resources.

8. The apparatus of claim 6, wherein the first transform precoding threshold number of frequency resources is equal to the second transform precoding threshold number of frequency resources.

9. The apparatus of claim 5, wherein the instructions are further executable by the processor to:
divide, according to a flooring or ceiling procedure, the plurality of frequency resources into a first portion comprising the first set of frequency resources and a second portion comprising the second set of frequency resources, wherein the first number of frequency resources is different from the second number of frequency resources.

10. The apparatus of claim 9, wherein the first transform precoding threshold number of frequency resources is different from the second transform precoding threshold number of frequency resources.

11. The apparatus of claim 1, wherein the instructions executable by the processor to transmit the first uplink message and the second uplink message comprise instructions executable by the processor to:
transmit the first uplink message via a first antenna panel to a first transmit/receive point in a multiple transmit/receive point deployment; and
transmit the second uplink message via a second antenna panel to a second transmit/receive point in the multiple transmit/receive point deployment.

12. An apparatus for wireless communications at a network entity, comprising:
a processor;
memory in electronic communication with the processor; and
instructions stored in the memory, wherein the instructions are executable by the processor to:
transmit an indication of a configuration of a first beam configuration and a second beam configuration;
transmit a downlink control information message comprising a frequency domain resource allocation field indicating a first set of frequency resources associated with the first beam configuration, wherein a first number of frequency resources in the first set of frequency resources satisfies a first transform precoding threshold number of frequency resources; and
receive a first uplink message using the first set of frequency resources according to the first beam configuration and a second uplink message using a second set of frequency resources according to the second beam configuration, wherein a second number of frequency resources in the second set of frequency resources satisfies a second transform precoding threshold number of frequency resources.

13. The apparatus of claim 12, wherein the instructions are further executable by the processor to:
extend the first set of frequency resources in the frequency domain to identify the second set of frequency resources, wherein the first number of frequency resources is equal to the second number of frequency resources.

14. The apparatus of claim 13, wherein the first transform precoding threshold number of frequency resources is equal to the second transform precoding threshold number of frequency resources.

15. The apparatus of claim 12, wherein the instructions are further executable by the processor to:
transmit, in the frequency domain resource allocation field, a single indication of a plurality of frequency resources comprising the first set of frequency resources and the second set of frequency resources.

16. The apparatus of claim 15, wherein the instructions are further executable by the processor to:
allocate a first portion of the plurality of frequency resources comprising the first set of frequency resources for the first beam configuration and a second portion of the plurality of frequency resources comprising the second set of frequency resources for the second beam configuration, wherein the first number of frequency resources is equal to the second number of frequency resources.

17. The apparatus of claim 16, wherein the plurality of frequency resources satisfies a threshold value equal to a sum of the first transform precoding threshold number of frequency resources and the second transform precoding threshold number of frequency resources.

18. The apparatus of claim 16, wherein the first transform precoding threshold number of frequency resources is equal to the second transform precoding threshold number of frequency resources.

19. The apparatus of claim 15, wherein the instructions are further executable by the processor to:
allocate, according to a flooring or ceiling procedure, the plurality of frequency resources into a first portion comprising the first set of frequency resources and a second portion comprising the second set of frequency resources, wherein the first number of frequency resources is different from the second number of frequency resources.

20. The apparatus of claim 19, wherein the first transform precoding threshold number of frequency resources is different from the second transform precoding threshold number of frequency resources.

21. A method for wireless communications at a user equipment (UE), comprising:
receiving an indication of a configuration of a first beam configuration and a second beam configuration;
receiving a downlink control information message comprising a frequency domain resource allocation field indicating a first set of frequency resources associated with the first beam configuration, wherein a first number of frequency resources in the first set of frequency resources satisfies a first transform precoding threshold number of frequency resources; and
transmitting a first uplink message using the first set of frequency resources according to the first beam configuration and a second uplink message using a second set of frequency resources according to the second beam configuration, wherein a second number of frequency resources in the second set of frequency resources satisfies a second transform precoding threshold number of frequency resources.

22. The method of claim 21, further comprising:
transform precoding the first uplink message based at least in part on the first number of frequency resources satisfying the first transform precoding threshold number of frequency resources, wherein transmitting the first uplink message is based at least in part on transform precoding the first uplink message; and
transform precoding the second uplink message based at least in part on the second number of frequency resources satisfying the second transform precoding threshold number of frequency resources, wherein transmitting the second uplink message is based at least in part on transform precoding the second uplink message.

23. The method of claim 21, further comprising:
extending the first set of frequency resources in the frequency domain to identify the second set of frequency resources, wherein the first number of frequency resources is equal to the second number of frequency resources.

24. The method of claim 23, wherein the first transform precoding threshold number of frequency resources is equal to the second transform precoding threshold number of frequency resources.

25. The method of claim 21, further comprising:
receiving, in the frequency domain resource allocation field, a single indication of a plurality of frequency resources comprising the first set of frequency resources and the second set of frequency resources.

26. The method of claim 25, further comprising:
dividing the plurality of frequency resources into a first portion comprising the first set of frequency resources and a second portion comprising the second set of frequency resources, wherein the first number of frequency resources is equal to the second number of frequency resources.

27. The method of claim 26, wherein the plurality of frequency resources satisfies a threshold value equal to a sum of the first transform precoding threshold number of frequency resources and the second transform precoding threshold number of frequency resources.

28. The method of claim 25, further comprising:
dividing, according to a flooring or ceiling procedure, the plurality of frequency resources into a first portion comprising the first set of frequency resources and a second portion comprising the second set of frequency resources, wherein the first number of frequency resources is different from the second number of frequency resources.

29. The method of claim 21, wherein transmitting the first uplink message and the second uplink message comprises:
transmitting the first uplink message via a first antenna panel to a first transmit/receive point in a multiple transmit/receive point deployment; and
transmitting the second uplink message via a second antenna panel to a second transmit/receive point in the multiple transmit/receive point deployment.

30. A method for wireless communications at a network entity, comprising:
transmitting an indication of a configuration of a first beam configuration and a second beam configuration;
transmitting a downlink control information message comprising a frequency domain resource allocation field indicating a first set of frequency resources associated with the first beam configuration, wherein a first number of frequency resources in the first set of frequency resources satisfies a first transform precoding threshold number of frequency resources; and
receiving a first uplink message using the first set of frequency resources according to the first beam configuration and a second uplink message using a second set of frequency resources according to the second beam configuration, wherein a second number of frequency resources in the second set of frequency resources satisfies a second transform precoding threshold number of frequency resources.
